(19) United States
(12) Patent Application Publication
(10) Pub. No.: US 2026/0221015 A1
(43) Pub. Date: Jul. 30, 2026

(54) GUNSHOT ANALYSIS USING ROBOT AUGMENTATION

(71) Applicant: Shooter Detection Systems, LLC, Newburyport, MA (US)

(72) Inventors: Richard Thomas Onofrio, Arlington, MA (US); Anthony John Franceschelli, JR., Norton, MA (US)

(21) Appl. No.: 19/463,691

(22) Filed: Jan. 29, 2026

Related U.S. Application Data
(60) Provisional application No. 63/750,813, filed on Jan. 29, 2025.

(51) Int. Cl. G08B 13/16; G05D 1/225; G05D 105/85; G05D 109/20

(52) U.S. Cl. CPC G08B 13/1672; G05D 1/225; G05D 2105/85; G05D 2109/20

(57) ABSTRACT

Methods, systems, and apparatus, including computer programs encoded on computer storage media, for robot gunshot response. One of the methods includes computing an estimated position of a predicted gunshot event in a physical environment; transmitting, using the estimated position of the predicted gunshot event, an instruction to cause a robot to navigate to a monitoring position within a threshold distance of the estimated position of the predicted gunshot event; receiving robot sensor data that includes sensor data captured by the robot and indicates a location for the robot when the robot sensor data was captured; determining whether to cause performance of another action for the predicted gunshot event using the robot sensor data; and in response to determining to cause performance of another action for the predicted gunshot event, causing performance of the action.

### CROSS-REFERENCE TO RELATED APPLICATION

This application claims the benefit of U.S. Provisional Application No. 63/750,813, filed on January 29, 2025, the contents of which are incorporated by reference herein.

### BACKGROUND

Gunshot detection can enhance safety by enabling a response to firearm-related incidents. These systems can utilize sensors to detect a gunshot. The sensors can be distributed throughout an environment to determine the location of the gunshot within the environment.

### SUMMARY

In general, one aspect of the subject matter described in this specification can be embodied in methods that include the actions of computing, by a monitoring system, an estimated position of a predicted gunshot event in a physical environment using a message i) received from a remote device in the physical environment, ii) that does not include location data for the remote device, and iii) is for the predicted gunshot event in the physical environment; transmitting, by the monitoring system and to a robot and using the estimated position of the predicted gunshot event, an instruction to cause the robot to navigate to a monitoring position within a threshold distance of the estimated position of the predicted gunshot event; receiving, by the monitoring system and from the robot, robot sensor data that includes sensor data captured by the robot and indicates a location for the robot when the robot sensor data was captured; determining, by the monitoring system, whether to cause performance of another action for the predicted gunshot event using the robot sensor data; and in response to determining to cause performance of another action for the predicted gunshot event, causing, by the monitoring system, performance of the action.

In general, one aspect of the subject matter described in this specification can be embodied in methods that include the actions of receiving, by a robot included in the system, navigation data that indicates a monitoring position within a threshold distance of an estimated position of a predicted gunshot event and includes an instruction for the robot to navigate to the monitoring position; while navigating to the monitoring position: capturing sensor data; determining whether the sensor data indicates an updated location for an entity that likely caused the predicted gunshot event; and in response to determining that the sensor data indicates an updated location for an entity that likely caused the predicted gunshot event, navigating to the updated location for the entity that likely caused the predicted gunshot event.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, the method can include receiving, by the monitoring system and from the robot, condition data that indicates a condition of the robot; determining, by the monitoring system and using the condition data, whether the condition of the robot satisfies a return criterion; and using a result of the determination whether the condition of the robot satisfies the return criterion, transmitting, by the monitoring system and to the robot, an instruction that causes the robot to navigate to a landing station for the robot.

In some implementations, the method can include determining, by the monitoring system and using the condition data, that the condition will likely satisfy the return criterion within a time window; determining a second monitoring position at which a second robot should monitor an entity for the predicted gunshot event; and transmitting, to the second robot that is different than the robot, a second instruction to cause the second robot to navigate to the second monitoring position to monitor the entity for the predicted gunshot event.

In some implementations, the time window can have a predetermined duration.

In some implementations, the return criterion can indicate that an entity for the predicted gunshot event should be monitored uninterruptedly. Transmitting the second instruction can cause the second robot to begin navigation toward the second monitoring position while the robot is at the monitoring position.

In some implementations, the second monitoring position can be a different position than the monitoring position.

In some implementations, the method can include receiving, by the monitoring system and from a device that includes at least one acoustic sensor and is located in the physical environment, a message that indicates a candidate gunshot event; determining that the candidate gunshot event is a second predicted gunshot event that is different than the predicted gunshot event in the physical environment; computing, by the monitoring system and using data for the device, a second estimated position of the second predicted gunshot event; determining, by the monitoring system and using the second estimated position, whether the second estimated position satisfies a distance threshold from the estimate position for the predicted gunshot event; and in response to determining that the second estimated position does not satisfy the distance threshold from the estimate position for the predicted gunshot event, causing, by the monitoring system and using the second estimated position of the second predicted gunshot event, a second robot that is different than the robot to navigate to a second monitoring position within a second threshold distance of the second predicted gunshot event.

In some implementations, the method can include receiving, by the monitoring system and from a device that includes at least one acoustic sensor and is located in the physical environment, a message that indicates a candidate gunshot event; determining that the candidate gunshot event is a second predicted gunshot event that is different than the predicted gunshot event in the physical environment; computing, by the monitoring system and using data for the device, a second estimated position of the second predicted gunshot event; determining, by the monitoring system and using the second estimated position, whether the second estimated position satisfies a distance threshold from the estimate position for the predicted gunshot event; and in response to determining that the second estimated position satisfies the distance threshold from the estimate position for the predicted gunshot event, causing, by the monitoring system and using the second estimated position of the predicted second gunshot event, the robot to navigate to a second monitoring position.

In some implementations, the second monitoring position can be within a second threshold distance of the second predicted gunshot event and the predicted gunshot event.

In some implementations, the method can include determining, by the monitoring system, whether to cause the robot to be deployed. transmitting, by the monitoring system and to the robot, the instruction can be responsive to determining to cause the robot to be deployed.

In some implementations, determining whether to cause the robot to be deployed can include: determining, using data for the message, a confidence level that indicates a likelihood that a gunshot event occurred; and determining whether the confidence level satisfies a confidence threshold and a robot should be deployed.

In some implementations, determining, by the monitoring system, whether to cause the robot to be deployed can include: accessing, by the monitoring system, weather information indicating at least one weather classification of the physical environment; and determining, by the monitoring system and using the weather information, whether the at least one weather classification of the physical environment indicates that the robot can likely operate in conditions indicated by the at least one weather classification. Transmitting the instruction to the robot can responsive to determining that the robot can likely operate in the conditions indicated by the at least one weather classification.

In some implementations, determining, by the monitoring system, whether to cause the robot to be deployed can include: accessing, by the monitoring system, permission information indicating whether the system is permitted to operate the robot autonomously; in response to determining that the system is not permitted to operate the robot autonomously, transmitting, by the monitoring system and to a robot operation system a request for an operator to operate the robot; and in response to the monitoring system receiving a response to the request, enabling, by the monitoring system, operation of the robot by the operator.

In some implementations, receiving, by the monitoring system and from the robot, the robot sensor data can include: receiving, by the monitoring system, video information representing a field of view of a camera of the robot; and determining, by the monitoring system and using the video information representing the field of view of the camera, whether the video information contains a representation of a person, a weapon, or both. Causing, by the monitoring system, performance of the action can use second data for the representation of a person, a weapon, or both.

In some implementations, the video information can contain a representation of a person. The method can include: determining, by the monitoring system and using the video information representing the field of view of the camera and the representation of the person, whether the representation of the person is moving in the field of view of the camera of the robot; in response to determining that the representation of the person is moving in the field of view of the camera, computing, by the monitoring system, a path that the representation of the person is likely to follow; computing, by the monitoring system and using the path of the representation of the person is likely to follow, a robot path which increases a likelihood of maintaining the representation of the person in the field of view of the camera; and transmitting, by the monitoring system and to the robot, an instruction that indicates that the robot should begin navigation along the robot path.

In some implementations, the method can include receiving, by the monitoring system and from a remote device that includes at least one acoustic sensor, the message that indicates the predicted gunshot event in the physical environment and acoustic data; and computing, by the monitoring system and using data for the remote device and the acoustic data, the estimated position.

In some implementations, the method can include generating, for presentation in a user interface: a first user interface element that indicates the estimated position of the predicted gunshot event in the physical environment; a second user interface element that indicates a current position for the robot in the physical environment; and a third user interface element that indicates a location of the remote device in the physical environment; and causing presentation of the user interface on a display.

In some implementations, receiving the navigation data can include receiving navigation data that was computed by another system using remote sensor data captured by a remote sensor in a physical environment that includes the predicted gunshot event and location data computed using a predetermined location for the remote sensor. capturing the sensor data can include: capturing the sensor data; computing a likely location of the robot when the sensor data was captured; and associating the sensor data with the likely location. Navigating to the updated location can use the likely location of the robot when the sensor data was captured that was associated with the sensor data.

In some implementations, the remote sensor data captured by the remote sensor might not include location data.

In some implementations, the method can include determining, using second sensor data captured by the robot or an instruction from another system, whether to perform an action for the predicted gunshot event; in response to determining to perform an action for the predicted gunshot event, selecting, from two or more predetermined actions, a specific action to perform for the predicted gunshot event; and performing, by the robot, the specific action, the specific action comprising one or more of: causing a speaker of the robot to broadcast an auditory signal, causing a light of the robot to emit a visual signal, or causing the robot to move to a second position that is different than the monitoring position.

In some implementations, performing the specific action can include performing the action at the monitoring position.

In some implementations, selecting the specific action can use second sensor data captured for the predicted gunshot event.

The subject matter described in this specification can be implemented in various implementations and may result in one or more of the following advantages. In some implementations, the systems and methods described in this specification can reduce risk; respond to gunshot events more quickly, more accurately, or both; monitor physical areas less likely covered by fixed sensors; or any combination of these. For instance, by responding to a predicted gunshot event with a robot instead of a person, risk for the person can be avoided by not having the person respond to the event. One or more of these advantages can be provided by transmitting, by the monitoring system and to a robot and using the estimated position of the predicted gunshot event, an instruction to cause the robot to navigate to a monitoring position within a threshold distance of the estimated position of the predicted gunshot event; in response to determining to cause performance of another action for the predicted gunshot event, causing, by the monitoring system, performance of the action; or both. In some implementations, the systems and methods described in this specification can increase a likelihood of monitoring an entity associated with a gunshot event by using condition data, e.g., that indicates a battery level of a robot, data for multiple gunshot events, or both. In some implementations, the systems and methods described in this specification can improve tracking an entity for a gunshot event, e.g., given an elevated position of a drone as a type of robot compared to other tracking mechanisms.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flow diagram for gunshot analysis using drone augmentation.

FIG. 2 is a flow diagram for obtaining additional information.

FIG. 3 is an infographic showing outdoor drone deployment.

FIG. 4 is a system block diagram for a gunshot sensor device with multichannel analysis.

FIG. 5 illustrates a multi-shooter decision flow diagram.

FIG. 6 is a block diagram for a support vector machine (SVM).

FIG. 7 is a flow diagram for machine learning (ML) training for a support vector machine.

FIG. 8 is a system diagram for gunshot analysis using drone augmentation.

FIG. 9 depicts an example of a physical environment.

FIG. 10 is a flow diagram of a process for gunshot analysis using robot augmentation.

FIG. 11 is a system diagram illustrating an example of a computing system.

Like reference numbers and designations in the various drawings indicate like elements.

### DETAILED DESCRIPTION

Detecting a gunshot event in real time using information from a combination of sensors can be advantageous. Gunshots can signify dangerous circumstances which can rapidly evolve, such as a moving armed person or a rapid flux of people responding to the gunshot. Further, the situation may continue to evolve after the gunshot has been detected. Monitoring the environment using fixed sensors, e.g., sensor devices, installed in the environment and mobile robots, e.g., drones, can enhance the safety of the environment. Although some examples refer to drones, these examples can equally apply to other appropriate types of robots. A reference to a mobile robot may refer to a robot operable in one or more motility modalities, e.g., a land-based, a sea-based, or an air-based drone. Examples in this specification that describe one particular modality can apply to others, e.g., to robots generally, when appropriate. The sensor devices can detect the gunshot and cause deployment of at least one drone. Optionally, the sensor devices can provide estimated gunshot position information to the deployed drone. Once deployed, the drone can monitor the estimated gunshot position, identify an armed person or weapon, follow a moving person, deploy one or more mitigation measures, transmit additional information to emergency personnel responding to the gunshot, or any combination of these.

This specification describes systems and methods for augmenting a gunshot detection system using a mobile drone. The system detects a gunshot event using one or more sensors, e.g., sensor devices or gunshot sensor devices, installed in an environment. Although some references might refer to “gunshot sensor devices,” the sensor devices might be used for other processes than gunshot detection. The system determines location information indicating an estimated position at which the gunshot may have occurred. The system deploys at least one mobile drone. The system provides the mobile drone with the location information. The system causes the mobile drone to navigate to a position having a field of view of the estimated position. The system may then cause the mobile drone to monitor the environment indicated by the location information. In some examples, the system provides the location information to the mobile drone. The mobile drone may use the location information to navigate to the position having the field of view of the estimated position. The mobile drone may then monitor the environment indicated by the location information.

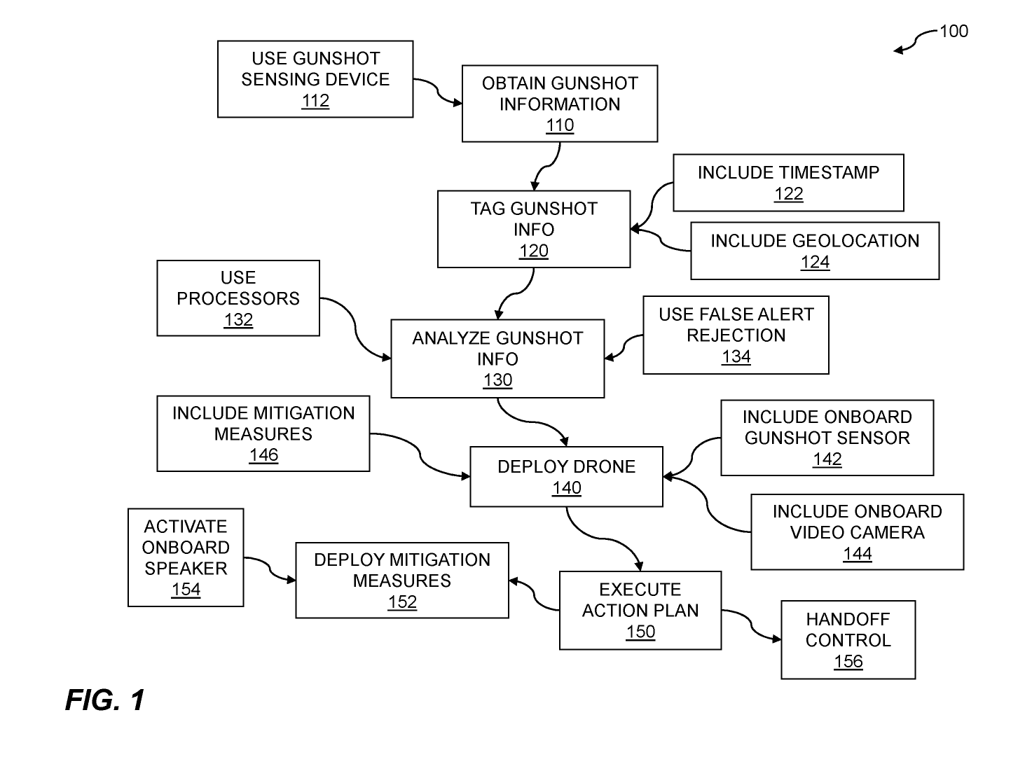

FIG. 1 is a flow diagram for gunshot analysis using drone augmentation. The flow 100 includes obtaining gunshot information 110 using one or more gunshot sensor devices 112. The gunshot sensor device can include a single unit, where the single unit can include one or more sensors, a processing element, a communication element, a power source, and so on. The gunshot sensor device can be contained within a housing. The gunshot sensor device can be mounted in an indoor space or an outdoor space. The gunshot sensor device can be mounted on an interior wall or ceiling, on a pole or a post, etc. The gunshot sensor device can be mounted in an outdoor setting on a post, a pole, a vertical wall, a bridge or overpass, and the like. The collecting infrared information is performed by two or more infrared sensors. The infrared (IR) information can include near-IR (NIR) information. The infrared sensor can sense one or more infrared bands, such as far-infrared (FIR) band light with wavelengths between 50-1000μm; a mid-infrared (MIR) band light with wavelengths between 3-50μm; and so on. The IR sensor can sense near-infrared (NIR) band light with wavelengths between 0.76-3μm. The two or more infrared sensors provide infrared information channels.

The obtaining gunshot information includes collecting acoustic information using the gunshot sensor device. The collecting acoustic information is performed by two or more acoustic sensors. The acoustic sensors can include one or more of a microphone, a high SPL microphone, a transducer, etc. The two or more acoustic sensors can detect acoustic signals based on one or more ranges of sound pressure levels (SPLs). The acoustic sensor can detect high SPL acoustic signals such as those associated with a gunshot sound event. The acoustic sensor can also detect muzzle blast sounds caused by hot, rapidly expanding gases emerging from a gun barrel. Gunshot information that is obtained from the acoustic sensors can be based on detecting shockwave and muzzle blast acoustics associated with a projectile fired in the vicinity of a gunshot sensor device. Each acoustic sensor within the gunshot sensor can receive the shockwave and/or muzzle blast at a slightly different time. The time difference information can be used to infer information about a gunshot, such as the approximate direction from which a projectile was fired, and/or the approximate speed of the projectile.

The gunshot information is georeferenced to at least one gunshot sensor device of the one or more gunshot sensor devices. The georeferenced location can include a location within a monitored campus. The monitored campus can include one or more structures such as a group of two or more multistory buildings that have been georeferenced. The monitored campus that is georeferenced can include sensor locations relative to an exterior map of a monitored campus facility. The map can be provided for multi-shooter incident analysis. The map can be obtained using various techniques for entry such as data entry. The sensor location relative to a map can be manually entered by a user. Other techniques can include automatic techniques. In embodiments, the sensor location relative to a campus map can be automatically entered by software. The tagging with the timestamp and the georeferenced location can include multi-dimensional tagging such as two-dimensional tagging. The two-dimensional tagging can tag gunshot information obtained from gunshot sensor devices within a monitored campus exterior. In embodiments, the tagging can include three-dimensional tagging. The three-dimensional tagging can be associated with different levels within an open space such as balconies associated with a theater or the side of a building. The three-dimensional tagging can be mapped to a multi-building campus map.

The gunshot information corresponds to a gunshot event. When a gun is fired, a bright flash of light is produced, along with infrared radiation. The two or more infrared sensors can detect the light flash, even in low-light conditions or through smoke and haze. In addition, small particles of gunshot residue are produced when a gun is fired. The infrared sensors can detect these particles using infrared spectroscopy. Some of these particles are ignited as they exit the gun barrel, producing additional infrared light waves. As each infrared sensor detects light and gunshot residue events from a gunshot, the infrared information can be collected and forwarded for processing. Each infrared sensor can forward its data through a separate information channel to be processed. The differences between the data collected from each of the two or more infrared sensors during the same event can be used in calculating the location and distance of the gunshot origin, as well as in classifying the event. Gunshots can be identified by their high sound pressure level acoustic signatures and the associated muzzle flashes. The acoustic signatures include muzzle blasts and acoustic shock waves. The acoustic signatures can vary significantly from firearm to firearm and between types of firearms such as long arms or handguns. The sounds generated by gunshots can be collected by each of the two or more acoustic sensors and translated into data that can be forwarded through separate information channels for analysis.

The flow 100 includes tagging the gunshot event 120 with a first timestamp 122 and a first georeferenced location 124, based on the at least one gunshot sensor device. The tagging with the timestamp and the georeferenced location can include multi-dimensional tagging such as two-dimensional tagging. The two-dimensional tagging can tag gunshot information obtained from gunshot sensor devices on a single structure. The tagging can include three-dimensional tagging. The three-dimensional tagging can be associated with different levels within an open space such the roof of a building, a balcony on the side of a building, etc. The three-dimensional tagging can be mapped to a multi-building campus. The campus can include exterior features such as playground equipment, park benches, tents, fountains, and so on.

The flow 100 includes analyzing, using one or more processors 132, the gunshot event 130, the first timestamp, and the first georeferenced location. Gunshot detection is based on analyzing gunshot information obtained from one or more gunshot sensor devices. The gunshot information that is obtained can include infrared information associated with a flash such as a muzzle flash, and high sound pressure level (SPL) information associated with a muzzle blast, explosion, and so on. The infrared information can be collected using one or more infrared sensors in a gunshot sensor device unit. The infrared information can be collected using near-infrared (NIR) band sensing. The NIR sensing can detect a muzzle flash and can provide motion detection. One or more IR sensors can be co-located in single gunshot sensor device unit. The gunshot sensor device can use cable-free communication to a network to send the obtained infrared information. The gunshot information that is obtained using the gunshot sensor device can further include acoustic information. The obtaining acoustic information is performed by at least one acoustic sensor co-located with the infrared sensor in the gunshot sensor device unit. The acoustic information can be used to identify a high-intensity gunshot sound, and to correlate, using the gunshot sensor device, the high-intensity gunshot sound to the infrared information that was obtained. The correlating can include establishing a temporal correspondence between the gunshot sound and an infrared event that occurred in time before the gunshot sound.

In embodiments, the gunshot event is determined from the gunshot information using false alert rejection 134. Gunshots can be identified by their high sound pressure level acoustic signatures and the associated muzzle flashes. The acoustic signatures include muzzle blasts and acoustic shock waves. The acoustic signatures can vary significantly from firearm to firearm and between types of firearms such as long arms or handguns. The sounds generated by gunshots can be collected by each of the two or more acoustic sensors and translated into data that can be forwarded through separate information channels for analysis. Information from gunshot events can be used to create sets of acoustic and infrared features which are related to various types or classes of gunshot events. In essence, a set of multi-dimensional “fingerprints” of infrared and acoustic datapoints can be created, with each datapoint fingerprint being related to a specific type or class of gunshot event. There are hundreds of different types of gun ammunition and thousands of types of guns. While both guns and ammunition can be broadly grouped into shotgun, handgun, and rifle categories, the number of combinations of the two is vast and ever changing. Thus, building a comprehensive library or datastore of infrared and acoustic features associated with each combination of firearm and ammunition is a challenging endeavor.

Machine learning models are well suited to building and maintaining such datastores, including the additional aspects of indoor and outdoor environments, weather conditions, multiple shot scenarios, and so on. Infrared and acoustic classifiers can be trained with libraries of data collected from firearm and ammunition manufacturers, government, and private sources. A classifier is created from an N-dimensional feature space, where the N-dimensional feature space results from a feature vector created from the features extracted from the infrared information and the acoustic information. The classifiers can be applied to the infrared information and to the acoustic information in series or in parallel. The classifiers can be used to improve classification of infrared data and acoustic data into one of two classes. The two classes can include a gunshot event class and a false alert class. The two or more classifiers can be used when a single classifier does not result in sufficiently accurate classification on the data. The classifiers can be trained using actual gunshot event data and actual false alert data.

A gunshot class can be computed based on output from a trained support vector machine (SVM) and additional output from the support vector machine. The extracted IR features and the extracted acoustic features can be processed through support vector machines. The SVMs are trained to implement classifiers, where the classifiers are used to compute a gunshot class for the IR and acoustic events detected by a gunshot sensor device. A first gunshot class includes a true gunshot event, while a second gunshot class includes a negative gunshot or false gunshot event. By correctly classifying true gunshot events and false alerts, the false alerts can be rejected as false, and no law enforcement or other action need be initiated.

The flow 100 includes deploying at least one drone 140 to the first georeferenced location, based on the analyzing. A drone is an aircraft that operates autonomously or by remote control, with no human pilot on board. Drones can be as small as a few inches in size up to models with wingspans exceeding 20 feet. Drones can use fixed wings, single rotors, multiple rotors, or combinations of wings and rotors. Some drones can use vertical take-off and landing (VTOL) flying capabilities, while others use fixed-wing designs with propellers at the front or rear of the aircraft. Drones can include global positioning systems (GPSs), still image cameras, video cameras, infrared cameras, wireless networking, obstacle avoidance, and so on. Drones can include battery systems allowing flight times from a few minutes to several hours, depending on the size of the drone and battery capacity. Drones can be stored in charging stations that include artificial intelligence (AI) processing, data storage, recharge equipment, and network communications to external facilities and operations centers. The first georeferenced location collected by the one or more gunshot sensor devices can be sent to the drone. Drone deployment to the first georeferenced location can be initiated within 30 seconds of a gunshot event being identified. Some drones, for example, can travel at speeds up to 14.5 km/hour and remain operational for 15 minutes, with an additional 5 minutes available for drone return and/or recovery.

Embodiments further comprise obtaining additional information about the gunshot event. The additional gunshot information can be obtained using the one or more gunshot sensor devices used for obtaining the gunshot information discussed above, or can be obtained from one or more other sensors. The additional gunshot information can include two or more additional gunshots. The additional gunshot information can be obtained for each gunshot. The additional gunshot information can indicate an additional gunshot event. The additional gunshot event can be associated with a same shooter associated with the first gunshot event or can be associated with a different shooter. The additional gunshot event can be associated with a weapon caliber substantially similar to the weapon caliber associated with the first gunshot event or can be a substantially different weapon caliber. Embodiments further comprise tagging the additional information with a second timestamp and a second georeferenced location. The additional gunshot event can be georeferenced to the monitored facility or campus. The additional gunshot event can be co-located with the first gunshot event, detected at a different location to the first gunshot, etc. The second timestamp and the second georeferenced location can be represented substantially similarly to the representing the first timestamp and first georeferenced location.

In embodiments, the additional information is sourced from the at least one drone. In embodiments, the at least one drone includes an onboard mobile gunshot sensor device 142. In embodiments, the at least one drone includes an onboard video camera 144. As mentioned above, the one or more drones can include a video camera. The video camera can be a low-light video camera. The video camera can be an infrared (IR) light camera. The one or more drones can include an acoustic sensor. The acoustic sensor can be connected to a pickup circuit with its gain set such that the sensor only picks up very loud noises (e.g., 110-130 decibels or greater), such as a muzzle blast, and does not pick up ordinary sounds, such as human conversation. In some configurations, a lower decibel threshold can be set to enable detection of acoustically suppressed (e.g., silenced) or lower caliber weapons. The one or more drones can include one or more processors that can analyze gunshot information collected by the camera and acoustic sensor included in the drones. The processor can be a mixed signal processor (MSP) microcontroller, an ultra-low-power controller, etc. The processor can be a TinyML processor. The one or more processors can include an AI model that can identify gunshot events. The video camera and acoustic sensor can send data to the one or more processors. The IR information that is collected can be based on various categories of IR light sensing such as near-infrared (NIR) band light with wavelengths between 0.76-3μm; mid-infrared (MIR) band light with wavelengths between 3-50μm; far-infrared (FIR) band light with wavelengths between 50-1000μm, etc. The acoustic sensors can detect acoustic signals based on one or more ranges of sound pressure levels (SPLs). The acoustic sensor can detect high SPL acoustic signals such as those associated with a gunshot sound event. The collecting acoustic information can be performed by a plurality of acoustic sensors that can be co-located in a single gunshot sensor device included in the one or more drones. The gunshot information can be forwarded to a drone base station or other compute device included in a wireless network established within the campus.

In embodiments, the at least one drone includes mitigation measures 146. The one or more drones can include a speaker. The speaker can be charged by the drone base unit, or can be charged separately. The speaker can generate up to 120 decibels in volume. The speaker can enable real-time audio signal broadcasting. The broadcasting can be used to sound a warning regarding an active shooter, to announce location information to law enforcement, to warn a shooter of alarms being raised, and so on.

The flow 100 includes executing an action plan 150, using the at least one drone, based on the gunshot event and a current location of the at least one drone. In embodiments, the additional information enables the executing. The additional information can be used to establish a present location of an active shooter, identify one or more additional shooters, identify a false alarm that was initially identified as a gunshot event, and so on. The additional information can be used to deploy one or more drones to a second location, based on an additional gunshot event. Confirmed gunshot events can be used to enable the drone to transmit video information to an operations center or law enforcement. Additional information collected by stationary gunshot sensor devices and/or mobile gunshot sensor devices included on the one or more drones can be used to track the movements of active shooters, inform law enforcement of shooter movements, and so on.

Embodiments further comprise deploying one or more mitigation measures 152. In embodiments, the mitigation measures include activating an onboard drone speaker 154. In embodiments, the speaker enables real-time audio signal broadcasting. As mentioned above and throughout, a speaker included in one or more drones can be used to sound a warning regarding an active shooter, to announce location information to law enforcement, to warn a shooter of alarms being raised, and so on. Law enforcement or security personnel can use the speaker to interact with the active shooter, warn others of a shooter, give instructions to others in the area of a shooter, and so on. Video can be streamed from a camera included in one or more drones to law enforcement or an operations center to allow security efforts to be coordinated, to deploy additional drones, and so on.

Embodiments further comprise handing off control 156 of the at least one drone to a human operator, based on further analyzing. Situations can arise that require a human to review and analyze audio and video data collected by the one or more drones. For example, a sound or IR light event that cannot be identified by the gunshot sensor device can result in a drone being deployed. A human operator can be notified that an event has occurred that has not been positively identified as a gunshot event, but cannot be ruled out as a false alarm. The human operator can review real-time video and audio data as it is transmitted by the drone and determine additional steps. For example, one or more additional drones can be deployed to gather additional information, security personnel can be deployed to the event location, the event can be determined to be a false alarm, and so on. The data collected by the gunshot sensor devices can be used to update the AI model so that false alarms and true gunshot events can be more easily identified in subsequent episodes.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

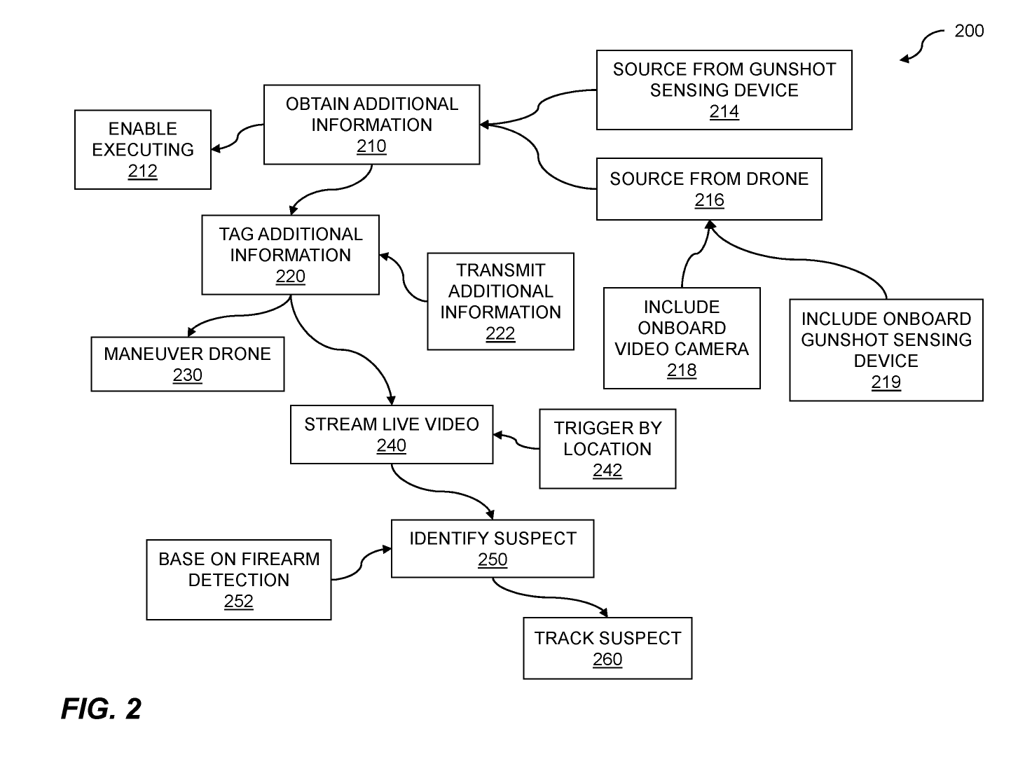

FIG. 2 is a flow diagram of obtaining additional information. As mentioned above and throughout, gunshot information corresponding to a gunshot event can be obtained using one or more gunshot sensor devices. The flow 200 further comprises obtaining additional information 210 about the gunshot event. The additional gunshot information can be obtained using the one or more gunshot sensor devices used for obtaining the gunshot information discussed above, or can be obtained from one or more other sensors. The additional gunshot information can include two or more additional gunshots. The additional gunshot information can be obtained for each gunshot. The additional gunshot information can indicate an additional gunshot event. The additional gunshot event can be associated with a same shooter associated with the first gunshot event or can be associated with a different shooter. The additional gunshot event can be associated with a weapon caliber substantially similar to the weapon caliber associated with the first gunshot event or can be a substantially different weapon caliber. Embodiments further comprise tagging the additional information with a second timestamp and a second georeferenced location. The additional gunshot event can be georeferenced to the monitored facility or campus. The additional gunshot event can be co-located with the first gunshot event, detected at a different location to the first gunshot, etc. The second timestamp and the second georeferenced location can be represented substantially similarly to the representing the first timestamp and first georeferenced location. In embodiments, the additional information enables the executing 212. The additional information can be used to establish a present location of an active shooter, identify one or more additional shooters, identify a false alarm that was initially identified as a gunshot event, and so on. The additional information can be used to deploy one or more drones to a second location, based on an additional gunshot event. Confirmed gunshot events can be used to enable the drone to transmit video information to an operations center or law enforcement communications network. Additional information collected by stationary gunshot sensor devices and/or mobile gunshot sensor devices included on the one or more drones can be used to track the movements of active shooters, inform law enforcement of shooter movements, and so on.

In embodiments, the additional information is sourced from the one or more gunshot sensor devices 214. Gunshot events can occur in rapid succession. More than one person can be involved so that multiple guns can be firing within a particular span of time. Automatic or semi-automatic guns can be used, so that many bullets can be fired from the same gun in a relatively short amount of time. A single shooter can fire a weapon multiple times. Acoustic and infrared events generated by gunfire can be echoed by walls, rocks, buildings, and other objects within an environment, and so on. Two or more infrared sensors can collect infrared information from each of the gunshot events encountered by the gunshot sensor devices. Two or more acoustic sensors can collect acoustic information from each of the gunshot events encountered by the gunshot sensor devices. Additional features can be extracted by the one or more gunshot sensor devices that receive infrared or acoustic data from additional gunshot events. Each sensor can provide acoustic or infrared information via acoustic or infrared information channels. The additional features can be processed to provide detections of one or more additional possible gunshot events. The processing provides detections of one or more possible gunshot events. The processing can be used to group infrared data and acoustic data into one of two classes. The two classes can include a gunshot event class and a false event class.

In embodiments, the additional information is sourced from the at least one drone 216. In embodiments, the at least one drone includes an onboard video camera 218. In embodiments, the at least one drone includes an onboard mobile gunshot sensor device 219. The onboard video camera can be a low-light video camera. The onboard video camera can be an infrared (IR) light camera. The one or more drones can include an acoustic sensor. The acoustic sensor can be connected to a pickup circuit with its gain set such that the sensor only picks up very loud noises (e.g., 110-130 decibels or greater), such as a muzzle blast, and does not pick up ordinary sounds, such as human conversation. A lower decibel threshold can be set on the acoustic sensor to enable detection of acoustically suppressed (e.g., silenced) or lower caliber weapons. The one or more drones can include one or more processors that can analyze gunshot information collected by the camera and acoustic sensor included in the drones. The processor can be a mixed signal processor (MSP) microcontroller, an ultra-low-power controller, etc. The processor can be a TinyML processor. The one or more processors can include an AI machine learning model that can identify gunshot events. The video camera and acoustic sensor can send data to the one or more processors. The video camera, acoustic sensors, processors, and AI machine learning model can comprise an onboard mobile gunshot sensor device. The IR information collected can be based on various categories of IR light sensing such as near-infrared (NIR) band light with wavelengths between 0.76-3μm; mid-infrared (MIR) band light with wavelengths between 3-50μm; far-infrared (FIR) band light with wavelengths between 50-1000μm, etc. The acoustic sensors can detect acoustic signals based on one or more ranges of sound pressure levels (SPLs). The acoustic sensor can detect high SPL acoustic signals such as those associated with a gunshot sound event. The collecting acoustic information can be performed by a plurality of acoustic sensors that can be co-located in a single gunshot sensor device included in the one or more drones. The gunshot information can be forwarded to a drone base station or other compute device include in a wireless network established within the campus.

Embodiments further comprise tagging the additional information 220 with a second timestamp and a second georeferenced location. The additional gunshot event can be georeferenced to the monitored facility or campus. The additional gunshot event can be co-located with the first gunshot event, detected at a different location to the first gunshot, etc. The second timestamp and the second georeferenced location can be represented substantially similarly to the representing the first timestamp and first georeferenced location. In embodiments, the at least one drone is maneuvered 230 based on the additional information. The additional information can be used to establish a present location of an active shooter, to identify one or more additional shooters, and so on. The additional information can be used to deploy one or more drones to a second location, based on an additional gunshot event. The first drone can be directed to a second location based on the additional information. One or more additional drones can be directed to additional locations based on the additional information. For example, an additional drone can be deployed to track a second shooter. An additional drone can be deployed based on the remaining battery life of the first drone. Additional drones can be deployed to likely next locations of an active shooter, based on the present location of the shooter and the direction of movement, and so on.

Embodiments further comprise transmitting the additional information 222 from the at least one drone to a network-connected computer. Live video and audio data collected by the one or more drones can be transmitted to a computer linked to the one or more networks which include the drones and the stationary gunshot sensor devices. The gunshot sensing data, including the AI model classifications of the gunshot events, can be transmitted to the computer as well. The networked computer can collate the data from the drones and stationary gunshot sensor devices and display the locations of gunshot events and active shooters on a 2D or 3D map of the campus. Additional information, such as law enforcement communications, building status, drone status, locations of security staff, and so on can be displayed by the computer. Live-stream video from the one or more drones can be displayed by the computer. The computer can be linked to internal security staff operations centers, law enforcement communications networks, public address systems, and so on.

Embodiments further comprise streaming live video information 240 from the video camera. In embodiments, initiation of the streaming is triggered by the drone location 242 relative to the georeferenced location. The video camera included in the one or more drones can be linked to a network communications device within the drone. Live video data from the camera can be sent to a building or campus wireless network, a drone base station, wireless mobile devices used by security staff or law enforcement, and so on. The onboard video camera can be placed in standby mode until the drone arrives at the deployment location determined by the gunshot sensor device. This can help to preserve battery life and allow the video to be streamed to the wireless network for as long as possible. Additional drones can be deployed to replace the first drone as battery life lowers, allowing the live video to continue as the gunshot event progresses.

Embodiments further comprise identifying a suspect 250, based on the live video information. In embodiments, the identifying is based on detection of a carried firearm 252. As mentioned earlier and throughout, machine learning models are well suited to building and maintaining datastores including aspects of indoor and outdoor environments, weather conditions, multiple shot scenarios, and so on. The machine learning models can include datastores that focus on identifying the presence and location of humans within a video frame. The models can be trained to pinpoint locations of key body joints, such as elbows, shoulders, knees, and so on in order to understand human posture and movement. Game databases can be used to train ML models to recognize humans carrying weapons, such as pistols, rifles, crossbows, and so on. Outlines, silhouettes, photos, and videos of humans carrying and using various weapons can train ML models to recognize key points of weapons as they are carried by humans in various poses – walking, running, crouching, and so on. As live video is captured by the drones, the video can be analyzed by one or more ML models included in the gunshot sensor devices to identify one or more suspects and weapons carried by the suspects. Embodiments further comprise tracking the suspect 260, based on the identifying. As one or more suspects are identified by live video feed included in the one or more drones, the location of the suspects can be sent to the drone base unit, a computer on the campus network, a law enforcement monitoring station, and so on. The one or more suspects can be shown in live-feed video from cameras on the drones. The locations of the suspects can be displayed on a 2D or 3D map included in a computer attached to a campus network. The locations can be sent to law enforcement or security personnel in real time, as the drones and stationary gunshot sensor devices gather data on additional gunshot events and follow the movements of the suspects. The drones can be rotated by humans controlling the drone deployment, or the drones can be deployed automatically in order to keep track of the suspects and keep the battery life of the drones sufficiently charged.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

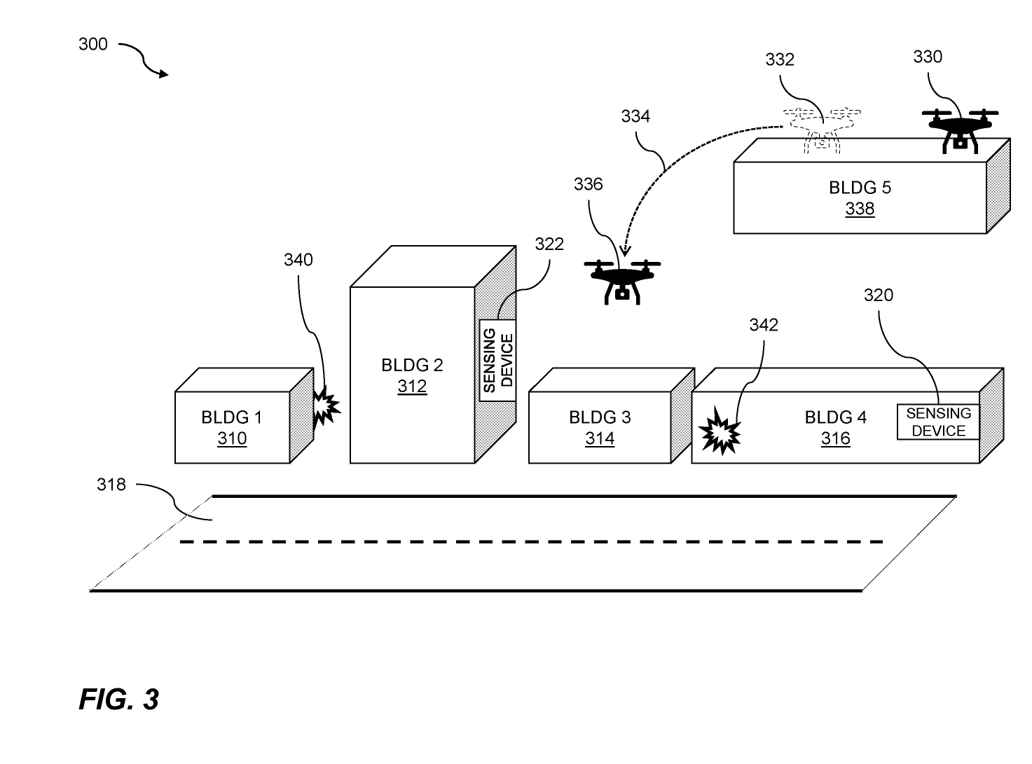

FIG. 3 is an infographic showing outdoor drone deployment. The FIG. 300 includes obtaining gunshot information using one or more gunshot sensor devices (320, 322), wherein the gunshot information is georeferenced to at least one gunshot sensor device of the one or more gunshot sensor devices, and wherein the gunshot information corresponds to a gunshot event 340. The infographic 300 includes five buildings: building 1310, building 2312, building 3314, building 4316, and building 5338. Buildings 2 and 4 have gunshot sensor devices 322 and 320, respectively, included on the exteriors of the buildings. A roadway 318 is shown beside buildings 1 through 4. Building 5 338 includes a drone 330. The drone can be housed in a base station (not shown) or charging station that is connected by wired or wireless network to a security operations center or other networked computer. The drone can include an onboard video camera. The drone can include an onboard mobile gunshot sensor device. The locations of the buildings, roadway, drone, and sensor devices can be georeferenced and marked in a 2D or 3D map included in the one or more computers attached to the campus wired and/or wireless networks.

The FIG. 300 includes a first gunshot event 340. Light and acoustic data generated by the event can be collected by the gunshot sensor device 322. As described above and throughout, the infrared (IR) light and acoustic data collected by the sensor device can be analyzed by an AI machine learning model included in the sensor device. A timestamp and georeferenced location of the gunshot event can be generated and recorded by the gunshot sensor device as the data is collected by IR and acoustic sensors included in the sensor device. The data collected by the one or more sensors can be compared to IR and acoustic profiles or classes of gunshot data generated by various types of handguns, long guns, and so on. IR and acoustic profiles of non-gunshot data that can have similar characteristics to gunshots can be included in the AI models and used to classify false alerts. For instance, video and audio of doors slamming, cars backfiring, camera flashes, fire alarms, and so on can be used to train the AI models to rule out these events and separate them from actual gunshot events.

The FIG. 300 can include deploying one or more drones, such as drone 336 (also shown as dotted line drone 332, before it takes off), based on the gunshot event 340. The drone 336 can be deployed based on the analysis of the gunshot event. The analysis can indicate that an actual gunshot has been detected. The analysis can indicate that an unknown event has occurred that may or may not be a gunshot. One or more human operators, including security personnel, law enforcement, and so on can be notified as the drone is deployed. The drone can travel 334 toward the georeferenced location of the first gunshot event 340 based on the data collected by the gunshot sensor device.

The FIG. 300 can include a second gunshot event 342 located near building 4316. The light and acoustic data generated by the second gunshot event can be captured by gunshot sensor device 320. As with the first gunshot event 340, the IR and acoustic data can be analyzed by the gunshot sensor device AI machine learning model. Georeferenced location and timestamp information can be collected and forwarded to the one or more network connected computers within the campus. The georeferenced data can be sent to the drone 336 and can be used to maneuver the drone to a location close to the second gunshot event 342. Depending on the video and/or IR and acoustic data collected by the drone 336, an action plan can be executed. For example, a single suspect can be tracked while the location of the suspect is sent to the networked computer. The location of the suspect can be displayed on a 2D or 3D map and forwarded to law enforcement or security personnel. A speaker included in the drone can sound a warning to individuals in the area of the suspect, warn the suspect that he or she is being monitored, play an alarm sound, and so on. Additional drones, such as drone 330, can be deployed to continue tracking and generating live feed video of the suspect, keeping law enforcement and security personnel informed as they deploy to contain and control the suspect.

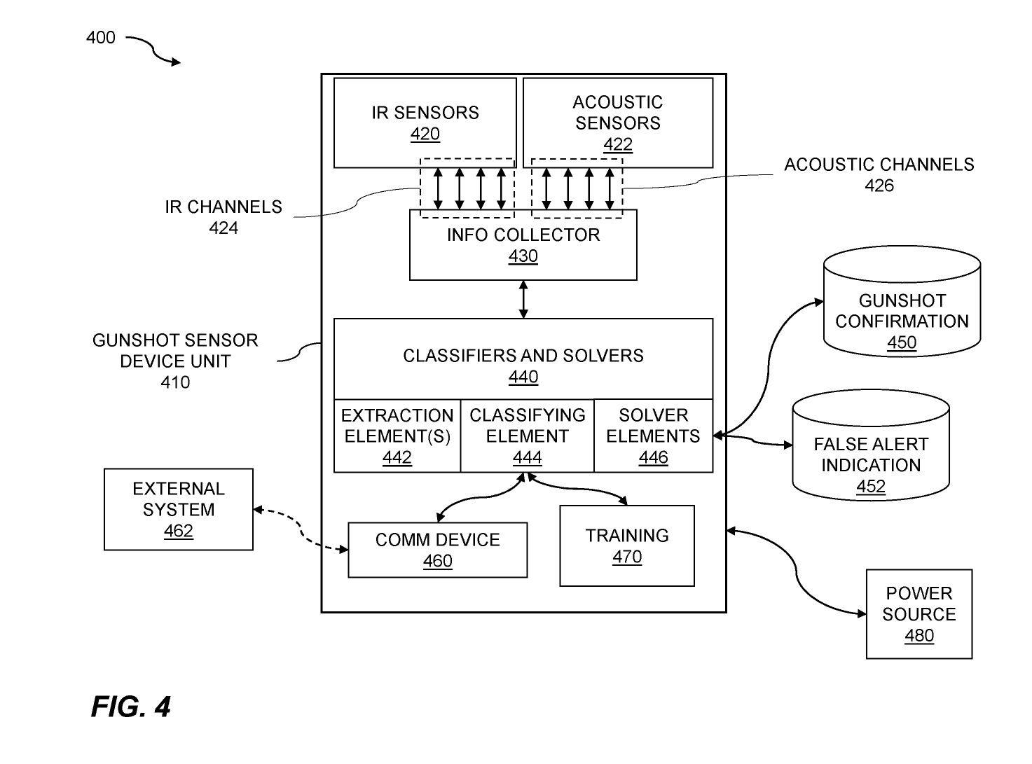

FIG. 4 is a system block diagram for a gunshot sensor device with multichannel analysis. The gunshot sensor device can be placed at an indoor location such as a school, at an outdoor location such as a stadium, in public spaces such as parks, etc. The gunshot sensor device can enable gunshot detection using multi-channel analysis. Infrared information and acoustic information are collected using a gunshot sensor device. The collecting infrared information is performed by two or more infrared sensors in a gunshot sensor device. The collecting acoustic information is performed by two or more acoustic sensors in the gunshot sensor device. Features are extracted from the infrared information and from the acoustic information. A gunshot event is identified. The gunshot event can trigger drone deployment.

The block diagram 400 includes a gunshot sensor device unit 410. The unit can contain components associated with the gunshot sensor device. The gunshot sensor device unit can comprise various materials and can provide protection against environmental hazards such as dust, dirt, precipitation, extreme temperatures, and the like. The unit can further provide protection against vandalism, tampering, etc. One or more components within the unit can be cooled. The block diagram 400 can include two or more infrared (IR) sensor 420. The IR sensors can be used to detect IR light in various IR bands. The IR sensors can detect IR light within the near-infrared (NIR) light band. The near-infrared (NIR) sensor can collect near-infrared information within an environment such as an indoor environment or an outdoor environment. The near-infrared sensor can detect near-infrared band light with wavelengths between 0.78μm and 4μm. The two or more infrared sensors can be oriented to cover different fields of view, overlapping fields of view, redundant fields of view, and so on. The near-infrared sensor can sense possible gunshot occurrences such as muzzle flashes. The two or more infrared sensors can provide separate infrared information channels 424. As an infrared sensor detects light and gunshot residue events from a gunshot, the infrared information can be collected and forwarded for processing. Each infrared sensor can forward its data through a separate information channel to be processed.

The infrared data can be forwarded to an information collector 430. The information collector can set up and configure the infrared sensors, evaluate the sensors, provide power control to the sensors, operate the sensors such that NIR information can be collected from the sensors, and so on. The information collector can collect IR information continuously, periodically, based on a potential gunshot event, etc. The information collector is coupled to the classifiers and solvers. The block diagram 400 can include two or more acoustic sensors 422. The two or more acoustic sensors can detect acoustic signals based on one or more ranges of sound pressure levels (SPLs). The acoustic sensor can detect high SPL acoustic signals such as those associated with a gunshot sound event. The collecting acoustic information can be performed by a plurality of acoustic sensors that can be co-located in a single gunshot sensor device. The two or more acoustic sensors can provide separate acoustic information channels 426. As an acoustic sensor detects supersonic and subsonic events from a gunshot, the acoustic information can be collected and forwarded for processing. Each acoustic sensor can forward its data through a separate information channel to be processed. As mentioned above, the acoustic data can be forwarded to an information collector 430. The information collector can set up and configure the acoustic sensors, evaluate the sensors, provide power control to the sensors, operate the sensors such that acoustic information can be collected from the sensors, and so on. The information collector can collect acoustic information continuously, periodically, based on a potential gunshot event, etc. The information collector is coupled to the classifiers and solvers.

The block diagram 400 includes classifiers and solvers 440 for the IR and acoustic information collected by the IR and acoustic sensors. The classifiers and solvers can include a feature extraction element 442 for IR information. The IR feature extraction element can extract features in proximity to the peak amplitudes. Proximity to the peak amplitudes can be based on an amount of time. The proximity can begin at least 20ms before a peak amplitude. Other amounts of time associated with the peak amplitude can describe proximity to the peak. The proximity can extend at least 100ms after a peak amplitude. The features that can be extracted from the IR signal can include time domain features. The time domain features can include positive and negative peak amplitudes, slopes between positive and negative peak amplitudes, ratios of the amplitudes of positive and negative peaks, time delays between an infrared peak and a collected acoustic peak, and squared values of the signal features.

The classifiers and solvers can include a feature extraction element 442 for acoustic information. The multiple elements can be associated with an object such as a data object. The multiple elements can include the extracted features from the acoustic information. The features can be adjusted, normalized, offset, and so on. The features can include scaled features. The scaling of the features can include a reduction in amplitude by an amount or percentage, a compression of dynamic range of the features, etc. The scaling of the features can improve processing performance, can avoid saturating computations by one or more support vector machines (SVMs), etc. At least one feature vector can include an N-dimensional feature space. The N-dimensional space can be based on a number of acoustic features.

The block diagram 400 includes one or more classifying elements 444. As mentioned above and throughout, a classifier is created from an N-dimensional feature space, where the N-dimensional feature space results from a feature vector created from the features extracted from the infrared information and the acoustic information. A gunshot class can be computed based on output from a trained support vector machine (SVM) and additional output from the support vector machine. The extracted IR features and the extracted acoustic features can be processed through support vector machines. The SVMs are trained to implement classifiers, where the classifiers are used to compute a gunshot class for the IR and acoustic events detected by a gunshot sensor device. A first gunshot class includes a true gunshot event, while a second gunshot class includes a negative gunshot or false gunshot event. By correctly classifying true gunshot events and false events, the false events can be rejected as false, and no law enforcement or other action need be initiated.

The classifiers and solvers include one or more solver elements 446. The solver elements can include two or more flash, shock, and muzzle solvers. The solvers can work together in a multi-sensor integration classifier to pair infrared and acoustic events with one another based on time and wave pattern analysis. Flash, shock, and muzzle solver information can be combined so that the three patterns of solver data describe a single event. The combination of flash data patterns, shock data patterns, and muzzle data patterns can be compared to data from a training datastore 470 to determine whether an event can be confirmed as a gunshot event 450 or as a false alert indication 452. The training datastore comprises data that has been marked or labeled to indicate one or more expected inferences about that data. Data classifications can include temporal and spectral features associated with infrared information and acoustic information. Time domain features can include positive and negative peak amplitudes, slopes between positive and negative peak amplitude, ratios of the amplitudes of positive and negative peaks, time delays between an infrared peak and an acoustic peak, squared values of the signal features, and earth mover distances to each of two class-average acoustic waveforms. The frequency domain features can include a Fast Fourier Transform of samples around an acoustic peak, logarithms of a Fast Fourier Transform of samples around an acoustic peak, and so on.

The block diagram 400 can include a communications device 460. The communications device can include a wired interface, a hybrid interface (e.g., wired and wireless), a wireless interface, and so on. The wireless interface can enable cable-free communication to one or more additional gunshot detection systems, to communication equipment, to a network such as a computer network or a cellular telephony network, and so on. The wireless interface can communicate using one or more wireless communication techniques including Wi-Fi, Bluetooth, Zigbee, near-field communication (NFC), and so on. The wireless interface may use a low power communication technique to reduce power consumption, to evade detection, to avoid interference with other wireless systems and services, etc. The cable-free communication to a network can include one or more power communication relay devices. A power communication relay device can detect a signal and retransmit the signal. The communication relay devices, or “repeaters”, can repeat a signal from the wireless interface to extend range, to transfer a signal from one wireless interface to another wireless interface, to convert the wireless signal to a wired signal, and the like. The block diagram 400 can include a power source 480. The power source can be distinct from the gunshot sensor device or can be integrated into, next to, or nearby the gunshot sensor device. The power source can include grid power, renewable power, battery power, and so on. A battery can include a rechargeable battery, a non-rechargeable battery, a single-use battery, and so on. A rechargeable battery may be recharged using a solar cell, a trickle charger, or the like. The battery can occupy less than 200 cubic centimeters of volume. The battery can include a nickel-cadmium battery, a sealed lead acid battery, a lithium iron phosphate battery, etc. Further configurations can include powering the gunshot sensor device using a solar panel coupled to the single gunshot sensor device unit. The solar panel can be used to recharge the battery which powers the gunshot detector.

The block diagram 400 can include an external system 462. The external system can include a video monitoring device. The video monitoring device can include one or more cameras, where the cameras can include webcams, video cameras, and so on. The cameras can include cameras that detect various light wavelength bands such as visible light bands, infrared light bands, and the like. Detection of a gunshot event can initiate communications with various services such as law enforcement, the military, first responders, and the like. The external system can provide data to a gunshot detection gateway. The notifying can include sending data as a stream or as packets, sending an email, sending a short message service (SMS) text, and the like. The external system can include one or more computers connected to a wired or wireless network. The computers receive data from the gunshot sensor devices and send updates to the classifiers and solvers. The external system can include one or more drones that can be connected to the wireless network or to the wired network via a base charging unit. Timestamp and georeferenced location information collected by the sensor device can be sent to the one or more drones using the communications device 460 included in the sensor device.

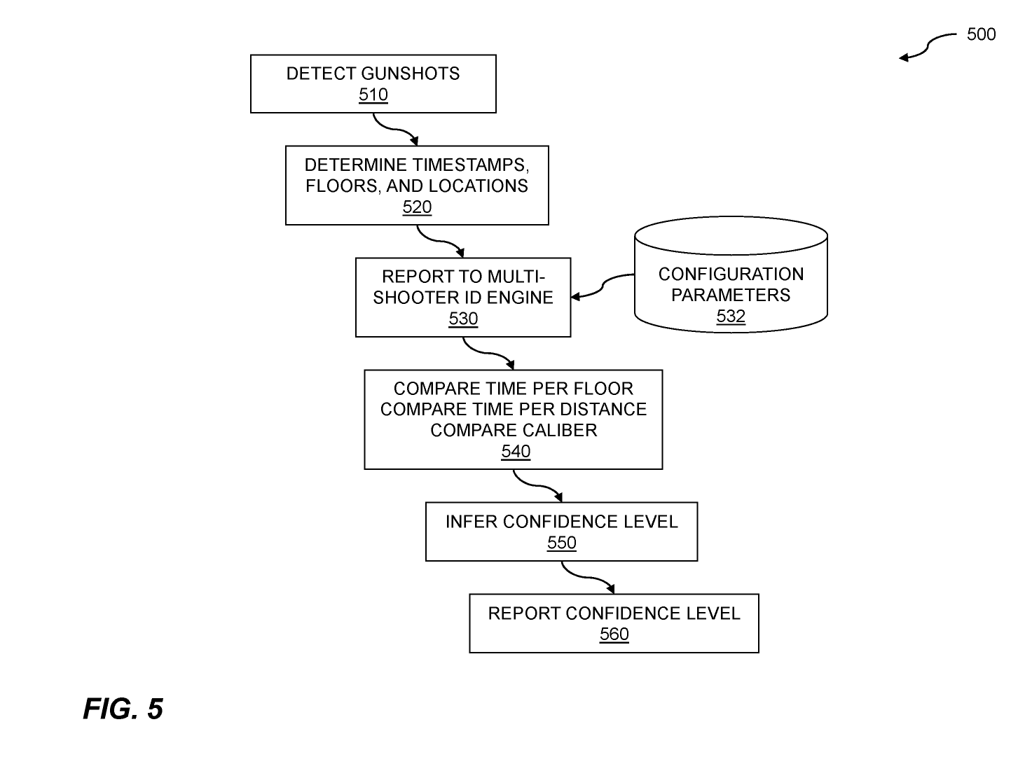

FIG. 5 illustrates a multi-shooter decision flow diagram. Discussed previously and throughout, gunshot analysis techniques can be used for multi-shooter incident identification. The analysis techniques can be based on configuration parameters, where the configuration parameters can be used by a multi-shooter identification engine to determine whether a plurality of detected gunshots is associated with a single shooter or multiple shooters. The rapid and accurate discrimination between a single-shooter incident and a multi-shooter incident can directly impact decision making for responses to the shooter incident. The responses can include evacuation plans for individuals within a building, law enforcement or military response to the incident, and so on. The determination of whether a shooting incident is a single-shooter incident or a multi-shooter incident can be based on a decision flow. The decision flow can be based on a variety of incident scenarios and proposed responses to those scenarios. The decision flow can include intervention by human experts. The decision flow enables multi-shooter incident identification using gunshot analysis. Gunshot information is obtained using one or more gunshot sensor devices, wherein the gunshot information is georeferenced to a monitored facility, and wherein the gunshot information corresponds to a gunshot event. The gunshot information is tagged with a first timestamp and a first georeferenced location. Additional gunshot information is obtained, wherein the additional gunshot information indicates an additional gunshot event, and wherein the additional gunshot event is also georeferenced to the monitored facility. The additional gunshot information is tagged with a second timestamp and a second georeferenced location. The gunshot information and the additional gunshot information are analyzed to identify a multi-shooter incident, based on the tagging. The gunshot information can be used to deploy one or more drones. The drones can collect additional gunshot information that can be used to track one or more gunshot suspects and enable action steps based on the gunshot information.

The illustration 500 includes detecting gunshots 510. Discussed previously and throughout, gunshot detection is based on analyzing gunshot information obtained from one or more gunshot sensor devices. The gunshot information that is obtained can include infrared information associated with a flash such as a muzzle flash, and high sound pressure level (SPL) information associated with a muzzle blast, explosion, and so on. The infrared information can be collected using one or more infrared sensors in a gunshot sensor device unit. The infrared information can be collected using near-infrared (NIR) band sensing. The NIR sensing can detect a muzzle flash and can provide motion detection. One or more IR sensors can be co-located in single gunshot sensor device unit. The gunshot sensor device can use cable-free communication to a network to send the obtained infrared information.

The gunshot information that is obtained using the gunshot sensor device can further include acoustic information. The obtaining acoustic information is performed by at least one acoustic sensor co-located with the infrared sensor in the gunshot sensor device unit. The acoustic information can be used to identify a high-intensity gunshot sound, and to correlate, using the gunshot sensor device, the high-intensity gunshot sound to the infrared information that was obtained. The collected IR information can be buffered. The correlating can include establishing a temporal correspondence between the gunshot sound and an infrared event that occurred in time before the gunshot sound.

The illustration 500 includes determining timestamps, floors, and locations 520. The determining the timestamps, floors, and locations can be accomplished by tagging. The gunshot information can be tagged with a first timestamp and a first georeferenced location. The first timestamp can be based on local time, universal time (e.g., GMT or UTC), a reference time, and so on. The timestamp can be based on a time reference such as a network time protocol (NTP), and the like. The georeferenced tagging can be based on a navigational standard such as GPS. The georeferenced information can be correlated with a plan such as a floorplan associated with the indoor space in which the one or more gunshot sensor devices have been deployed. The georeferenced information can be correlated with a plan such as a campus map associated with outdoor space in which one or more gunshot sensor devices have been deployed. The correlating the georeferenced information with the map and/or floorplan can determine an outdoor campus location, a floor within a structure such as a multi-floor structure, a location on the floor, and so on. The additional gunshot information can be tagged with a second timestamp and a second georeferenced location. The second timestamp can be based on a substantially similar time reference as the first timestamp. The second georeferenced location can be based on a substantially similar navigational standard. The georeferenced information associated with the additional gunshot information can be correlated with a building floorplan and/or outdoor campus map. The timestamps, the buildings, the floors, and the locations can be analyzed to determine relative separations at the time of gunshot events, and whether the gunshot events occurred on the same or different floors, in the same or different buildings, between buildings, and so on. The distance separating the first gunshot event and the second gunshot event can be determined. The tagging and the analyzing can include a multi-shooter identification engine.

The illustration 500 includes reporting the gunshot information to a multi-shooter identification (ID) engine 530. The gunshot information can include IR information such as NIR information, acoustic information such as high SPL information, and so on. The information that is reported to the multi-shooter ID engine further includes the tagging information comprising timestamps, georeferenced location, and so on. The multi-shooter ID engine can be based on one or more processors, where the one or more processors can be co-located with the one or more gunshot sensor devices; can be accessible to the gunshot sensor devices using wired, wireless, or hybrid connections such as network connections; and so on. In the illustration 500, the multi-shooter identification engine includes configuration parameters 532. The configuration parameters can be uploaded by a user, downloaded from a library of configuration parameters, and the like. The configuration parameters can be based on floorplans associated with an indoor environment such as a building. The building can include a school, hospital, enterprise, public building, government building, etc. The configuration parameters can be based on campus maps associated with an outdoor environment such as a college campus, outdoor mall, fairground, park, marina, etc. The configuration parameters can include a minimum time per floor(s), a minimum time per distance, and a caliber detection enablement control.

Various techniques can be applied for using the configuration parameters. The configuration parameters can be used heuristically. Heuristic use of the configuration parameters can provide an “educated guess” about the gunshot information obtained from the one or more gunshot sensor devices. The educated guess by the heuristic, in contrast to a calculated result by an algorithm, can be determined quickly. The heuristic use of the configuration parameters can provide a fast result for locations of gunshot incidents, a likelihood that a gunshot incident is a multi-shooter incident, and so on. Discussed previously, the configuration parameters can be adjusted, modified, updated, and so on for a facility that is monitored using gunshot sensor devices. The configuration parameters can be tailored to the monitored facility. In a usage example, a configuration parameter can include the minimum amount of time required to ascend to a floor or descend from a floor, move from one building to another, and so on. The minimum amount of time can be adjusted or tailored based on the height of each story in the monitored facility, the outdoor weather conditions, amount of daylight, and so on. The configuration parameters can be used for further purposes to assist gunshot analysis. The configuration parameters can be used for machine learning training. A machine learning model can be trained for gunshot analysis for a monitored facility.

Discussed previously and throughout, the gunshot information and the additional gunshot information can be analyzed to determine whether a gunshot incident is associated with a single-shooter incident or a multi-shooter incident. The analysis can be based on comparing the gunshot information and the additional gunshot information to configuration parameters. The illustration 500 includes comparing 540 the gunshot information and the additional gunshot information to the time per floor, the time per distance, and caliber comparison. The determination of whether a gunshot incident is a single-shooter or multi-shooter incident can be based on evaluating one or more of the configuration parameters. A variety of usage examples are discussed below. One of the usage examples is recited here. In a usage example, gunshot information that includes an incident time of 10:00:00, a campus indication of first building, north side, a location X on the north side, and a weapon caliber of low caliber is obtained. Additional gunshot information that includes an incident time of 10:00:02, a campus indication of first building, a location X + 50 feet to the east, and a weapon caliber of low caliber is obtained. Given a configuration parameter of time per distance equal to 1 second per 10 feet, a single shooter cannot cover the 50-foot difference in location in the seconds that elapsed between detection of the first gunshot at 10:00:00 and detection of the second gunshot at 10:00:02. Thus, a multi-shooter incident is likely.

The illustration 500 further includes inferring a multi-shooter determination confidence level 550, based on the identifying. A confidence level can be based on a percentage of times that the same predicted result can be determined based on analyzing the gunshot information and the additional gunshot information. That is, it can be determined that a gunshot incident is likely to be a multi-shooter incident or a single-shooter incident. The confidence level can be high, such as for the example just presented. The confidence level can be low when the analysis of the gunshot information and the additional gunshot information produces fewer clear results. In another usage example, gunshots are detected, where the gunshots are detected only a few feet, such as five feet, apart. Based on the configuration parameter for time per distance of 1 second per 10 feet, a single-shooter incident could be inferred. However, if the calibers associated with the two gunshots are different, then the inference is less clear. That is, the two gunshots could be associated with two different shooters, or the two gunshots could be associated with a single shooter firing two different weapons. The resulting confidence level would likely be low. Thus, additional gunshot information could be obtained to determine whether the gunshots can be associated with a single shooter or multiple shooters. The additional gunshot information can include two or more additional gunshots. The additional information can be analyzed to determine separation distance increases between subsequent gunshots. The additional information can include video data from the vicinities of the gunshots, and so on.

The illustration 500 further includes reporting 560 the multi-shooter determination confidence level to security personnel. The security personnel can include safety and security personnel associated with an owner or operator of the spaces in which the gunshot sensor devices are deployed. The security personnel can include emergency services, law enforcement, military, and other personnel. The reporting can be accomplished using communications channels, where the communications channels can include channels that operate using wired techniques, wireless techniques, hybrid wired and wireless techniques, and the like. The reporting can include voice messages, text messages, email messages, and so on. The reporting can be accomplished using virtual private network (VPN) techniques, encrypted messaging techniques, secured channels, etc.

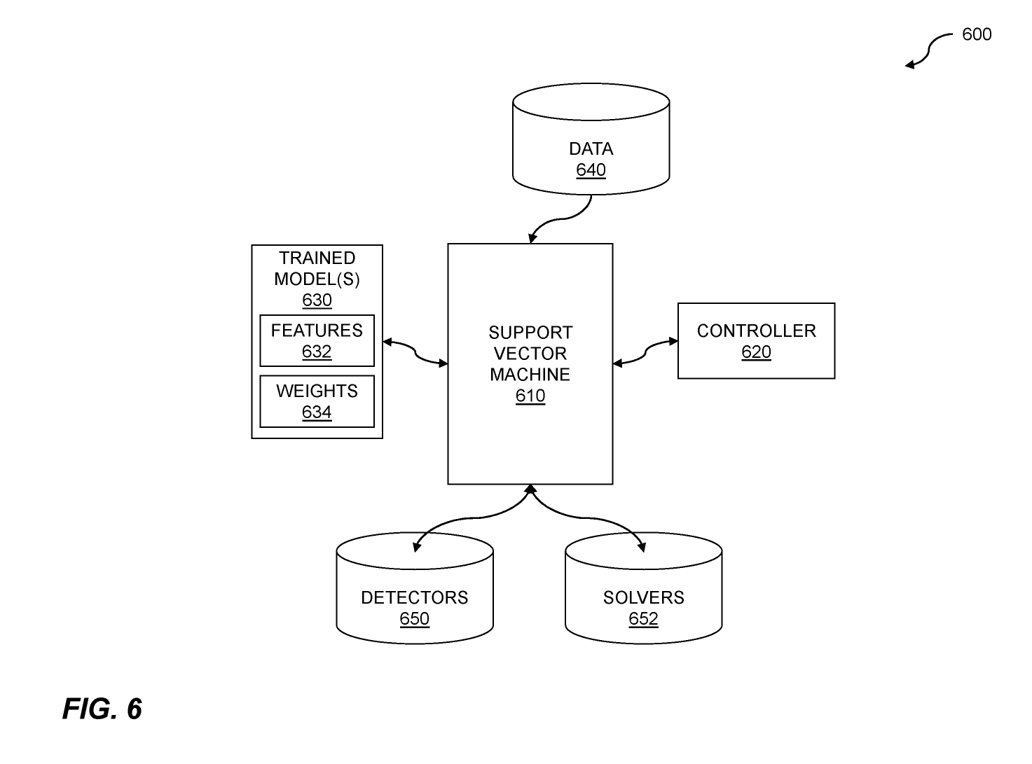

FIG. 6 is a block diagram for a support vector machine (SVM). A support vector machine (SVM) can be based on an algorithm, such as a machine learning (ML) algorithm. The machine learning algorithm can include a deep learning algorithm. The machine learning algorithm enables a machine learning technique, where the machine learning technique enables gunshot detection. The ML technique is enabled by the SVM. The SVM can include a class of kernel machine, where a kernel machine can be used for pattern analysis. The SVM can be used to process data, including infrared (IR) data such as near-infrared (NIR) data and acoustic data, in order to identify patterns, trends, clusters, and the like within the data. The SVM can be used to classify the data. Classifying the data can include assigning data to one of two classes based on inferences drawn on the data. The inferences that are drawn are based on a machine learning algorithm that has been trained. The inferences associated with the data can include identifying, by the SVM, that the data can be a member of one class such as a first class, or a member of another class such as a second class. The SVM can be executed on one or more processors, a network such as a neural network, one or more processor cores, and so on. The support vector machine enables gunshot detection with false alert rejection. Infrared information is collected using a gunshot sensor device, wherein the collecting infrared information is performed by at least one infrared sensor in a gunshot sensor device unit. Acoustic information is collected using the gunshot sensor device, wherein the collecting acoustic information is performed by at least one acoustic sensor co-located with the infrared sensor in the gunshot sensor device unit. Features are extracted from the infrared information and the acoustic information, wherein at least one of the features describes a first signal shape for the infrared information and at least one of the features describes a second signal shape for the acoustic information. The features extracted from the infrared information are processed through one or more trained support vector machines. The features extracted from the acoustic information are processed through at least one support vector machine. A gunshot class is computed, based on output from the one or more trained support vector machines and additional output from the at least one support vector machine. The SVM can be used for determining drone deployment.

The block diagram 600 can include a support vector machine (SVM) 610. The SVM can enable a machine learning algorithm, heuristic, procedure, and so on. The SVM can comprise one or more processors, processor cores, and the like. The processors can be configured in a network. The network can include a configurable network. The SVM can be implemented using code. The code can include code generated by a high-level compiler such as a C, C++, or Python compiler; a special-purpose compiler; etc. The code can further include an assembly code or similar low-level code. The block diagram 600 can include a controller 620. The controller can be used to obtain and direct data to the SVM, to select and load a trained SVM model, etc. The controller can be used to enable further learning by the trained learning model. The block diagram 600 can include a trained ML model 630. The trained ML model can be based on an algorithm, where the algorithm has been trained by providing a training dataset for processing by the algorithm. The training dataset comprises data that has been marked or labeled to indicate one or more expected inferences about that data. The training dataset can include marked or labeled features, where the features 632 can be extracted from infrared information and from acoustic information.

The training dataset is used to adjust parameters such as weights and biases associated with the trained SVM. The SVM model can further include weights 634 and biases (not shown). The weights and the biases enable the trained ML model to make desired inferences about data. The inferences can be based on classifications. The classifications can include temporal (time domain) features and spectral (frequency domain) features associated with the infrared information and the acoustic information. The time domain features can include positive and negative peak amplitudes, slopes between positive and negative peak amplitudes, ratios of the amplitudes of positive and negative peaks, time delays between an infrared peak and an acoustic peak, squared values of the signal features, and earth mover distances to each of two class-average acoustic waveforms. The frequency domain features can include a Fast Fourier Transform of samples around an acoustic peak, logarithms of a Fast Fourier Transform of samples around an acoustic peak, and so on.

The trained ML model can be executed on the SVM in order to process data. The processing of data can accomplish computing a gunshot class. The block diagram 600 includes data 640. The data includes the collected infrared information and the collected acoustic information. The processing of the data can include detectors 650 and solvers 652. The flash, shock, and muzzle detectors and solvers can analyze the infrared and acoustic data separately, then combine the analyses to determine the presence of a true gunshot event, an absence of a gunshot event or a false event, an alarm, a lightning flash, a reflection off a vehicle, etc. The determining can be based on a positive result or a negative result of the computing a gunshot class. The determining can include evaluating the product of scaled and vectorized signal features and a weight vector, with an added bias, as a positive result or a negative result. The positive result and the negative result can be used for a variety of purposes. A positive result can indicate a first classification, and a negative result can indicate a second classification. The first and second classifications can include a presence or confirmation of an event (e.g., a positive result), or an absence of an event (e.g., a negative result). The positive result and the negative result can be used to determine a true gunshot event, to reject a false alert, and so on. The positive result and the negative result can be used to differentiate between types of firearms. The first classification can be a long gun bullet caliber classification, and the second classification can be a handgun bullet caliber classification. The long gun bullet caliber classification can be associated with a long gun such as a rifle, a shotgun, and so on. The long gun can include a bolt-action, semiautomatic, or automatic weapon, etc. The handgun can include a revolver or semiautomatic weapon, and the like.

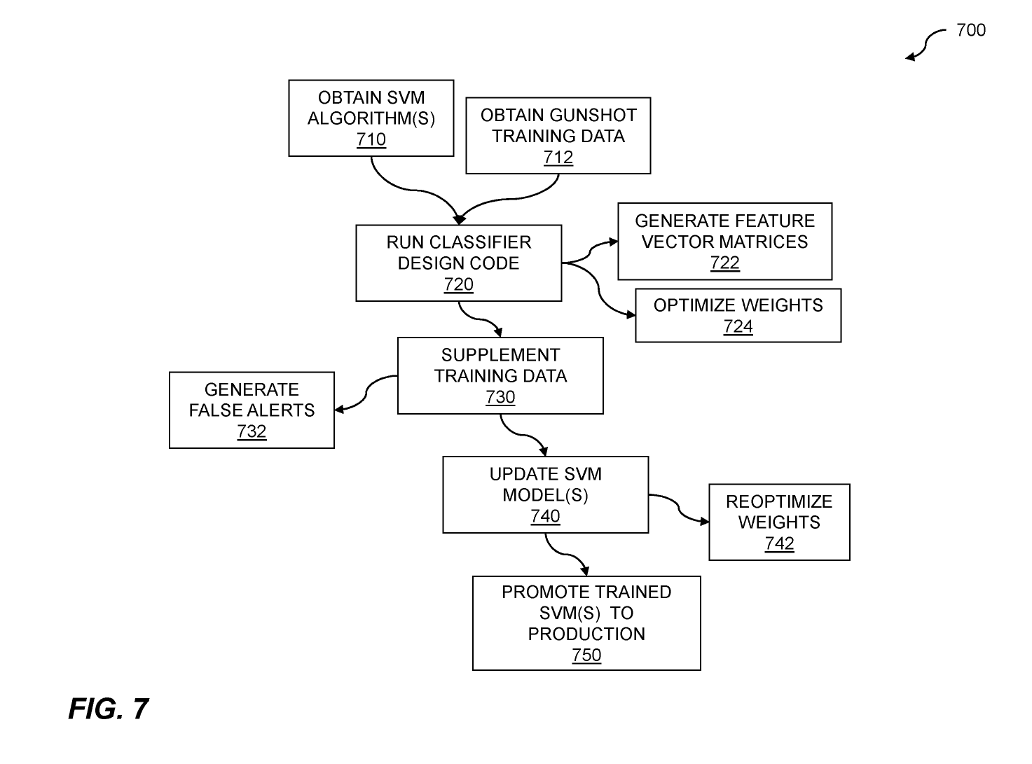

FIG. 7 is a flow diagram for machine learning (ML) training for a support vector machine. Discussed previously, a support vector machine (SVM) can be based on a machine learning algorithm that can be used for pattern analysis of data. The pattern analysis can include classification of the data into one of two classes. The SVM must be trained in order for the SVM to accomplish the classification of the data. The training can be based on providing a training dataset, where the training dataset includes “labeled” or “tagged” data. The training dataset can include labeled features. The features are extracted from collected infrared information and from collected acoustic data. A label associated with the data can include a classification. The training data is applied to the SVM, and weights and biases associated with the SVM can be adjusted. The adjustment of the weights and biases associated with the SVM can continue until the SVM correctly classifies the training data as being a member of one of two classes. The adjustments can also accomplish faster convergence of the SVM to determine the correct classification of the data. The training the SVM enables gunshot detection with false alert rejection. Infrared information is collected using a gunshot sensor device, wherein the collecting infrared information is performed by at least one infrared sensor in a gunshot sensor device unit. Acoustic information is collected using the gunshot sensor device, wherein the collecting acoustic information is performed by at least one acoustic sensor co-located with the infrared sensor in the gunshot sensor device unit. Features are extracted from the infrared information and the acoustic information, wherein at least one of the features describes a first signal shape for the infrared information and at least one of the features describes a second signal shape for the acoustic information. The features extracted from the infrared information are processed through one or more trained support vector machines. The features extracted from the acoustic information are processed through at least one support vector machine. A gunshot class is computed, based on output from the one or more trained support vector machines and additional output from the at least one support vector machine. The gunshot class can be used as a factor in drone deployment.

The flow 700 includes obtaining 710 one or more support vector machine (SVM) algorithms. An SVM algorithm can include a machine learning (ML) model. The ML model can be uploaded by a user, downloaded from a repository such as an online library or cloud storage, and so on. The ML model can include a general-purpose model, a previously trained model, and the like. The model can be associated with the Kernel Method for machine learning. The algorithm associated with the Kernel Method can be used for pattern analysis. The flow 700 can include obtaining 712 gunshot training data. The gunshot training data can include marked or labeled training data. The marked training data can include data that has been analyzed by human experts, a previously trained ML model, and so on. In a usage example, a collection of infrared flash information data has been analyzed by human experts. The human experts have classified some of the infrared flash information as containing gunshot flash events and other infrared flash information as containing false gunshot flash events. The human experts have further classified acoustic information and other sound recordings as containing gunshot events and other acoustic information and sound recordings as containing false acoustic events. The false event information can include flashes of sunlight such as reflections off of shiny surfaces, fireworks, strobes, etc. The false event information can further include vehicle backfires, door slams, thunder, earthquakes, etc. The marked training data can be applied to the ML algorithm in order to train or tune the algorithm to correctly classify gunshot events within the marked infrared and acoustic information. The ML algorithm can further classify false gunshot events.

The flow 700 includes running classifier design code 720. The classifier design code can access the training data, where the training data includes gunshot information data collected from firing of handguns, rifles, shotguns, and so on. The gunshot information can be based on one or more calibers such as common handgun calibers ranging from .22 to .45; rifle calibers such as common hunting rifle calibers such as .223, .243, .30-30,.30-06, and 7.62; common shotgun calibers including .410, 20 gauge, 16 gauge, and 12 gauge; and the like. In the flow 700, the classifier design code generates 722 matrices of features. Recall that the features can include infrared features and acoustic features. The features can include frequency domain features and time domain features. The infrared features and the acoustic features can be combined into at least one feature vector. More than one feature can result from combining the IR and the acoustic features. At least one feature vector can include scaled features. In the flow 700, the running the classifier design code can optimize weights 724. The weights can be associated with a machine learning model, where the machine learning model can be executed on the SVM. The feature vector matrices and the optimized weights can be used to obtain a best overall classification rate. In order to obtain a best overall classification rate, careful selection of training data is performed. The selecting can be performed by a user. Further techniques can be used to select training data. The selecting can be performed by a trained ML model. The ML model for selecting can be executed on an SVM, on a neural network, and so on.

Training of machine learning models can be based on a variety of machine learning techniques. The machine learning techniques can include supervised training, unsupervised training, and so on. Supervised learning is based on providing a training dataset that has been marked or labeled. The labeling, which can be accomplished by human experts who have examined the dataset, indicates an inference that the supervised learning model is expected to make based on the dataset. Supervised learning of the SVM is based on applying the marked training data to the ML algorithm. The training accomplishes adjustments to the algorithm so that the algorithm can correctly classify the training data. The classifying can include detecting the presence or absence of a flash such as infrared flash. The adjustments that can be made to the ML algorithm for training purposes can include adjusting weights, applying a bias, and so on. The adjusting of the weights can include varying a weight for each computation associated with the SVM. The adjusting the weights can include an iterative technique where the adjusting the weights can continue throughout the processing of the training dataset. Biases associated with the SVM can also be determined and adjusted. The bias can include the distance between a hyperplane separating clusters of points associated with classifications determined by an SVM.

The flow 700 includes supplementing 730 the training data. The marked training data can be supplemented with additional marked training data. The additional marked training data can include data generated by human experts. The additional data can include historical data. The additional marked training data can include synthetic data. The synthetic data can be generated using a generative technique, where the generative technique generates and marks data that can be substantially similar to the marked data generated by the human experts. The generative technique can generate more marked data faster than can the human experts. In the flow 700, the supplementing the training data includes generating false alerts 732. The false alerts, or “negative results”, can be used to improve inference by an ML model that IR information and/or acoustic information is associated with a false gunshot event.

The flow 700 includes updating 740 the one or more SVM models. The updating the SVM models can be based on updating a supervised learning model. The supplemental, marked training data can be applied to the supervised ML model. The supplemental training can be used to reoptimize the ML weights 742. The adjusting can further include adjusting the ML biases. The updating of the learning model can continue while the supplemental training data is available, until the ML model meets or exceeds a classification accuracy threshold, while convergence speed increases, and the like. The flow 700 includes promoting the one or more trained SVMs to production 750. The promoting can indicate that the ML model is ready for processing of “production” or real data. The trained SVM can continue to learn based on the application of production data. The continued learning can be based on a semi-supervised training technique, an unsupervised training technique, etc.

Various events such as infrared (IR) flash events and acoustic events can be classified. Discussed previously and throughout, the IR events can be associated with lightning flashes, fireworks, strobes such as fire alarm strobes, and so on. The IR events can include flashes of sunlight such as flashes resulting from the sunlight reflecting off of water, vehicle windshields, building windows, mirrors, and other shiny surfaces. The acoustic events can include high sound pressure level (SPL) events such as thunder, vehicle backfires, door slams, heavily amplified music, etc. The IR flash events and the acoustic events can be associated with gunshot events. The classifying can be used to determine a likelihood that an IR flash event and/or an acoustic event is associated a particular class. In a usage example, an IR flash event and an acoustic event are detected. By processing data associated with the flash event and the acoustic event, a determination can be made as to whether the flash event and the acoustic event may have been caused by a gunshot event or not. If not, then further classifying can be performed in order to determine another possible cause of the event.

Discussed previously, signal features can be extracted from collected infrared information and from collected acoustic information. The signal features surrounding at least one local peak can be extracted. The signal features can include time domain features such as positive peak amplitude, negative peak amplitude that follows an initial positive peak, pre-peak infrared level, and a ratio of a positive peak amplitude to a negative peak amplitude that follows an initial positive peak. The time domain features can include features associated with the peak, such as peak width at percentages showing a positive peak amplitude at 25%, 50%, 75%, and/or 97% values. The time domain features can include energy values associated with the peak. The time domain features associated with energy include peak pulse energy, pre-peak energy, post-peak energy, and/or the ratio of post-peak energy to pre-peak energy. The time domain features can further include rising and falling slopes, rising and falling edge counts, and so on. The features can further include frequency domain features. The frequency domain features can include a Fast Fourier Transform (FFT) of samples surrounding a local peak. The frequency domain features can also include logarithms of a Fast Fourier Transform of samples surrounding a local peak. An FFT can be performed on samples surrounding the peak in batches of up to 25ms. However, using a longer sampling time batch, such as 100ms, can enable the testing of feature statistics over time. The classifying can be based on the time domain features, the frequency domain features, or both.

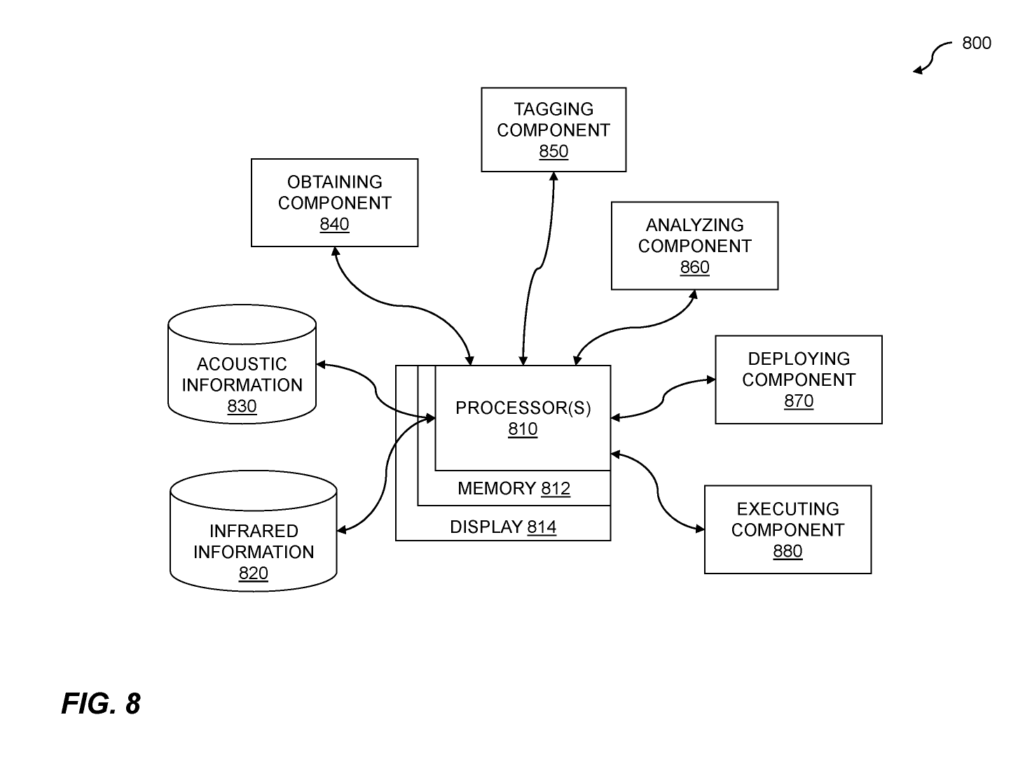

FIG. 8 is a system diagram for gunshot analysis using drone augmentation. The system 800 can include one or more processors 810 coupled to a memory 812 which stores instructions. The system 800 can include a display 814 coupled to the one or more processors 810 for displaying data, prompts, decoy files, authentication methods, intermediate steps, instructions, and so on. In embodiments, one or more processors 810 are coupled to the memory 812 where the one or more processors, when executing the instructions which are stored, are configured to: obtain gunshot information using one or more gunshot sensor devices, wherein the gunshot information is georeferenced to at least one gunshot sensor device of the one or more gunshot sensor devices, and wherein the gunshot information corresponds to a gunshot event; tag the gunshot event with a first timestamp and a first georeferenced location, based on the at least one gunshot sensor device; analyze, using one or more processors, the gunshot event, the first timestamp, and the first georeferenced location; deploy at least one drone to the first georeferenced location, based on the analyzing; and execute an action plan, using the at least one drone, based on the gunshot event and a current location of the at least one drone.

The system 800 includes SVM gunshot training data. The gunshot training data can include marked or labeled training data. The marked training data can include data that has been analyzed by human experts, a previously trained ML model, and so on. The training data can include a collection of infrared information 820. The infrared information can be analyzed and classified. Some of the infrared information can be classified as containing gunshot flash events and other infrared information as containing false gunshot flash events. The training data can include a collection of acoustic information 830 and other sound recordings containing gunshot events and other acoustic information and sound recordings containing false acoustic events. The false event information can include flashes of sunlight such as reflections off of shiny surfaces, fireworks, strobes, etc. The false event information can further include vehicle backfires, door slams, thunder, earthquakes, etc. The SVM training information can be applied to the ML algorithm in order to train or tune the algorithm to correctly classify gunshot events within the infrared and acoustic information. The ML algorithm can further classify false gunshot events infrared (IR) information.

The system 800 includes an obtaining component 840. The obtaining component 840 includes functions and instructions for obtaining gunshot information using one or more gunshot sensor devices, wherein the gunshot information is georeferenced to at least one gunshot sensor device of the one or more gunshot sensor devices, and wherein the gunshot information corresponds to a gunshot event. The collecting infrared information is performed by two or more infrared sensors included in the one or more gunshot sensor devices. The infrared (IR) information can include near-IR (NIR) information. The obtaining gunshot information includes collecting acoustic information using the gunshot sensor device. The collecting acoustic information can be performed by two or more acoustic sensors. The acoustic sensors can include one or more of a microphone, a high SPL microphone, a transducer, etc.

The system 800 includes a tagging component 850. The tagging component 850 includes functions and instructions for tagging the gunshot event with a first timestamp and a first georeferenced location, based on the at least one gunshot sensor device. The tagging with the timestamp and the georeferenced location can include multi-dimensional tagging such as two-dimensional tagging. The two-dimensional tagging can tag gunshot information obtained from gunshot sensor devices on a single structure. The tagging can include three-dimensional tagging. The three-dimensional tagging can be associated with different levels within an open space such the roof of a building, a balcony on the side of a building, etc. The three-dimensional tagging can be mapped to a multi-building campus. The campus can include exterior features such as playground equipment, park benches, tents, fountains, and so on.

The system 800 includes an analyzing component 860. The analyzing component 860 includes functions and instructions for analyzing, using one or more processors, the gunshot event, the first timestamp, and the first georeferenced location. Gunshot detection is based on analyzing gunshot information obtained from one or more gunshot sensor devices. The gunshot information that is obtained can include infrared information associated with a flash such as a muzzle flash, and high sound pressure level (SPL) information associated with a muzzle blast, explosion, and so on. The infrared information can be collected using one or more infrared sensors in a gunshot sensor device unit. One or more IR sensors can be co-located in single gunshot sensor device unit. The gunshot information that is obtained using the gunshot sensor device can further include acoustic information. The obtaining acoustic information is performed by at least one acoustic sensor co-located with the infrared sensor in the gunshot sensor device unit. The acoustic information can be used to identify a high-intensity gunshot sound, and to correlate, using the gunshot sensor device, the high-intensity gunshot sound to the infrared information that was obtained. The correlating can include establishing a temporal correspondence between the gunshot sound and an infrared event that occurred in time before the gunshot sound. Information from gunshot events can be used to create sets of acoustic and infrared features which are related to various types or classes of gunshot events. In essence, a set of multi-dimensional “fingerprints” of infrared and acoustic datapoints can be created, with each datapoint fingerprint being related to a specific type or class of gunshot event. Infrared and acoustic classifiers can be trained with libraries of data collected from firearm and ammunition manufacturers, government, and private sources. The classifiers can be applied to the infrared information and to the acoustic information in series or in parallel. The classifiers can be used to improve classification of infrared data and acoustic data into one of two classes. The two classes can include a gunshot event class and a false alert class. The two or more classifiers can be used when a single classifier does not result in sufficiently accurate classification on the data. The classifiers can be trained using actual gunshot event data and actual false alert data.

The system 800 includes a deploying component 870. The deploying component 870 includes functions and instructions for deploying at least one drone to the first georeferenced location, based on the analyzing. The drones can use fixed wings, single rotors, multiple rotors, or combinations of wings and rotors. The drones can include global positioning systems (GPS), infrared cameras, wireless networking, obstacle avoidance, and so on. The drones can be stored in charging stations that include artificial intelligence (AI) processing, data storage, recharge equipment, and network communications to external facilities and operations centers. The first georeferenced location collected by the one or more gunshot sensor devices can be sent to the drone. Drone deployment to the first georeferenced location can be initiated within 30 seconds of a gunshot event being identified. The drone can travel at speeds up to 14.5 km/hour and remain operational for 15 minutes, with an additional 5 minutes available for drone recovery.

The system 800 includes an executing component 880. The executing component 880 includes functions and instructions for executing an action plan, using the at least one drone, based on the gunshot event and a current location of the at least one drone. The additional information can be used to establish a present location of an active shooter, identify one or more additional shooters, identify a false alarm that was initially identified as a gunshot event, and so on. The additional information can be used to deploy one or more drones to a second location, based on an additional gunshot event. Confirmed gunshot events can be used to enable the drone to transmit video information to an operations center or law enforcement. Additional information collected by stationary gunshot sensor devices and/or mobile gunshot sensor devices included on the one or more drones can be used to track the movements of active shooters, inform law enforcement of shooter movements, and so on.

The system 800 can include a computer program product embodied in a non-transitory computer readable medium for gunshot analysis, the computer program product comprising code which causes one or more processors to perform operations of: obtaining gunshot information using one or more gunshot sensor devices, wherein the gunshot information is georeferenced to at least one gunshot sensor device of the one or more gunshot sensor devices, and wherein the gunshot information corresponds to a gunshot event; tagging the gunshot event with a first timestamp and a first georeferenced location, based on the at least one gunshot sensor device; analyzing, using one or more processors, the gunshot event, the first timestamp, and the first georeferenced location; deploying at least one drone to the first georeferenced location, based on the analyzing; and executing an action plan, using the at least one drone, based on the gunshot event and a current location of the at least one drone.

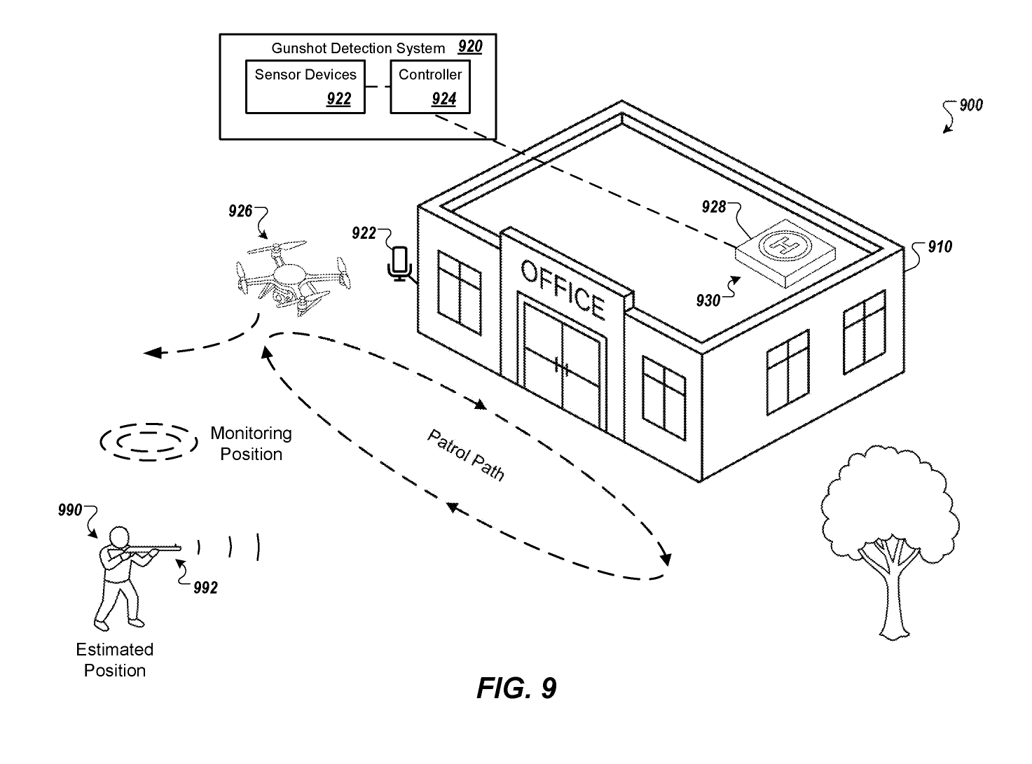

FIG. 9 depicts an example of a physical environment 900. The environment 900 includes a building 910 at a premises. The building 910 and the surrounding environment 900, e.g., the premises that includes the building, is being monitored by a gunshot detection system 920. The gunshot detection system 920 can perform various operations to detect a predicted gunshot event and perform corresponding actions. The gunshot detection system 920 can use a robot to capture sensor data for an event, reduce a likelihood of an event or a subsequent event, or both.

The gunshot detection system 920 includes a sensor device 922. The sensor device 922 can be mounted to the building 910, e.g., physically fixed in the environment 900 such as attached to the building 910. The sensor device 922 can include at least one acoustic sensor, at least one infrared sensor, or both. The one or more sensors of the sensor device 922 can capture acoustic energy, infrared energy, or both, from the environment 900, e.g., using corresponding sensors. The one or more sensors can generate signals from the received energy, e.g., an acoustic sensor can generate acoustic signals, or an infrared sensor can generate infrared signals, or both.

The gunshot detection system 920 includes or is communicatively coupled to a robot system 930. The robot system 930 can include at least one robot 926 and, optionally, a robot base 928 for receiving the robot 926. When the robot system 930 only includes the robot 926, examples that describe transmission of data from the robot 926 to another system can include transmission of that data to the gunshot detection system 920. The robot system 930 can operate independently from the gunshot detection system 920 to monitor the environment 900, e.g., the premises. In some examples, the gunshot detection system 920 is communicatively coupled to the robot system 930 to operate the robot system 930, e.g., and provides commands to the robot system 930.

The robot 926 depicted in FIG. 1 can be an example of a robot configured for air travel, e.g., which can be called a ‘drone.’ In some examples, the robot 926 may be a robot configured for terrestrial travel, liquid travel, or a hybrid of combinations of terrestrial, liquid, or air travel.

The robot 926 can include one or more sensors. In some examples, the robot 926 includes at least one acoustic sensor, at least one infrared sensor, or both. The sensors of the robot 926 can receive energy from the environment 900 and generate respect of signals from the received energy. The robot 926 can transmit the generated signals to the robot system 930, the gunshot detection system 920, or both. The robot 926 can transmit the generated signals on a continuous basis, when certain transmission criteria are satisfied, or both. Some example transmission criteria can include the robot system 930 sending an instruction to the robot 926 to transmit the generated signals, or the gunshot detection system 920 detecting a gunshot.

The robot 926 can include any appropriate sensors. For instance, the robot 926 can include observational devices to monitor one or more different aspects of the environment 900. The robot 926 may include visual observation devices, e.g., a camera, or observation devices to cover other electromagnetic spectrums, e.g., an IR camera, or an ultraviolet (“UV”) camera. In some instances, the camera can be part of the same sensor device as the infrared sensor. The robot 926 may include other signal collection devices such as a radio frequency (“RF”) device (e.g., an RF spectrum analyzer), a GPS device (e.g., a GPS signal integrity monitor), or a wireless communications scanner (e.g., wi-fi or Bluetooth signal scanner).

The robot 926 may include notification devices for broadcasting notifications in the vicinity of the robot 926. The notification devices may include a speaker for broadcasting audio messages, a light source for broadcasting visual notifications, or both.

The robot system 930 can monitor at least some of the environment 900 using the robot 926. The robot system 930 may store in memory one or more patrol paths which cover at least a portion of the environment 900. The patrol paths can include paths that would cause the robot 926 to capture sensor data for the entire premises. The robot 926 may traverse a patrol path to monitor a portion of the premises. The robot system 930 may control the robot along the patrol path, or the robot 926 may traverse the patrol path independently from control of the robot system 930. The robot 926 of FIG. 1 is shown operating along a patrol path. The patrol path is shown along one side of the building 910, through the patrol path may cover any portion of the environment 900 or the premises.

FIG. 9 depicts a person 990 or a vehicle (not shown) operating a weapon 992 in the environment 900. The vehicle can be an autonomous vehicle, such as a robot that is separate from the robot 926 for the robot system 930. Although examples described in this specification refer to a person 990, similar examples can apply, when appropriate, to the vehicle or another automated system controlling the gun. The person 990 operating a weapon 992 can create a gunshot signal in the environment 900. The gunshot signal can include an acoustic signal, an infrared signal, or both. For example, the gunshot signal can generate a bright flash in an IR spectrum and an optical spectrum. The gunshot signal can generate a loud acoustic report in the environment 900.

The sensors of the sensor device 922 can receive the gunshot signal. The sensors can generate signals representing one or more portions of the gunshot signal. The sensor device 922 can process the generated signals through one or more engines, machine learning models, or both, to determine whether the generated signals indicate a gunshot event took place in the environment 900. In some instances, a machine learning model can be a specific type of engine.

The machine learning models can include at least one classifier, at least one solver, or a combination of these. The gunshot sensor device can provide the generated signals to separate ones of two or more machine learning models in parallel or in sequence. Examples of classifiers may include a fireworks classifier, a vehicle backfire classifier, or a gunshot classifier. The classifiers can output of data representing the likelihood of the classification the classifier is trained to provide. For example, the gunshot classifier can output a likelihood value of a received signal indicating a gunshot event in the environment 900.

The sensor device 922 can provide the likelihood values to the solvers. The solvers can use the likelihood values to verify the classifications. The solver may compare the likelihood value indicating the gunshot event in the environment 900 to the gunshot event threshold. If the gunshot event likelihood value satisfies the gunshot event threshold, the sensor device 922 may provide data to the controller 924 indicating that a gunshot event has occurred in the environment 900. The controller 924 can be implemented on the sensor device 922 or a separate device, e.g., another computer in the gunshot detection system 920.

The sensor device 922 can use the signals generated by the sensors to determine an estimated position of the gunshot event. The estimated position of the gunshot event can be determined using the acoustic signal, the infrared signal, or both. In some examples, the gunshot detection system 920 can use estimated positions from more than one sensor device to determine an average estimated position which may have higher accuracy than the estimated positions generated by individual sensor devices.

The estimated position of the gunshot event can be the estimated position of a gun, e.g., a source of the event; the estimated position of an object that was hit with a projectile emitted from the gun, e.g., a target event; or some combination of both. A combination of both positions can be an average position, e.g., between the two positions; two separate positions, e.g., one for each event; or another appropriate position. In this specification, the estimated position of the gunshot event generally refers to the estimated position of the gun, e.g., and the person 990 who held the gun when the gunshot event occurred. In some examples, the gun might be remotely operated, e.g., in which case the estimated position is separate from whatever person or device triggered the gun.

The gunshot detection system 920 can perform one or more actions in response to receiving the data indicating the gunshot event occurred in the environment 900. The gunshot detection system 920 may keep a list of actions to perform. The gunshot detection system 920 can use the received data and the list of actions to select an action to perform for a particular predicted gunshot event. In some examples, the gunshot detection system 920 can use an artificial intelligence engine to determine an action to perform using at least some of the received data. In some examples, gunshot detection system 920 may determine to cause a robot 926 to maneuver to a monitoring position within a threshold distance of an estimated position of the gunshot event. The monitoring position can be a position separate from the patrol path, or separate from a current area for the robot 926 of the patrol path.

The gunshot detection system 920 may transmit instructions to the robot 926 to cause the robot 926 to navigate to the monitoring position. In some examples, the gunshot detection system 920 may provide the robot 926 with the estimated position, the monitoring position, or both, and the robot 926 may independently maneuver to the monitoring position.

The robot 926 can maneuver to the monitoring position. The robot 926 may include an optical monitoring system, e.g., a camera. The robot 926 may maneuver until the estimated position of the gunshot event, e.g., and the gun, the person 990, or both, is in a field of view of the camera of the robot 926. In some examples, the camera may be on a rotatable mount on the robot 926. The robot 926 may actuate the rotatable mount to point the camera until the person 990 is in the field of view of the camera.

The robot 926 can perform one or more actions while the gun, the person 990, or both, are in the field of view of the camera. The robot 926 may transmit one or more audio communications, emit one or more visual notifications, or a combination of actions. In some instances, the robot 926 can navigate to retrieve, disable, or both, the gun. In some examples, the robot 926 may include the trained gunshot detection machine learning models. The robot 926 may process energy from the environment 900 to determine whether a gunshot event has occurred in the environment 900, such as using energy from the estimated position.

In some examples, the person 990, the gun, or both, may move from the estimated position while in the field of view of the camera of the robot 926. The robot 926 may track a location of the person 990, e.g., monitor changes in the location of the person 990. The robot 926 may transmit an updated position to the robot system 930, the gunshot detection system 920, or both. The robot 926 may generate an estimated position, or an estimated path, of the person 990 moving in the field of view of the camera. The robot 926 may determine that the estimated position or the estimated path is outside of the field of view of the camera, the robot 926 may determine to move to a second monitoring position. In some examples, the robot 926 may transmit the estimated position or the estimated path to the gunshot detection system 920 or the robot system 930 with a request for permission to move to the second monitoring position.

In some instances, the robot system 930 in the environment 900 may require manned control for one or more reasons. As examples, the infrastructure, population, traffic patterns, or any combination of these, may create challenges for fully autonomous navigation and decision-making. Human operators can provide real-time judgment to avoid hazards, address privacy concerns, respond to emergencies or unexpected events that automated systems may not handle effectively, or any combination of these. Human operation of the robot 926 may increase safety, compliance with one or more regulations, adaptability in changing conditions, or any combination of these. Examples of situations which may be required or beneficial to be handled by human operation include compliance with local air traffic regulations, adverse weather conditions for robot flight, customer preference, or a congested airspace for robot flight.

The robot system 930 may store in memory one or more criterion for requesting human operation of the robot 926. The criterion may correspond to human operation being required, or preferred. In some examples, the air safety regulations of the environment 900 may require a human to operate the robot 926. The robot system 930 may transmit data including a request for human operation of a robot 926 to one or more remote operation systems.

The robot system 930 may receive a request for control of the robot 926 from a remote operation system. The robot system 930 may handoff operation of the robot 926 to the remote operation system. The robot system 930 may receive a request to autonomously control the robot 926 from the remote operation system in instances when human operation is no longer required or preferred. The robot system 930 may take control of the robot 926, return autonomous control to the robot 926, or both, in response to receiving the request.

The robot system 930 may include more than one robot, e.g., a second robot that is different than the first robot 926. The robot system 930 including more than one robot may facilitate increasing the portion of the environment 900 being monitored. The robot system 930 may operate the second robot in parallel with the first robot 926, or independently from the first robot 926. The robot system 930 may operate the second robot along the same patrol path as the first robot 926, or a second, different patrol path. The second, different control path might or might not overlap with the first patrol path.

The robot 926 may determine that one or more conditions of the robot satisfies a return criterion. A return criterion can be a criterion that, when satisfied, indicated that the robot 926 should return to a predetermined location. The predetermined location can be the robot base 928 or another appropriate location. Some examples of conditions of the robot can include a battery condition, e.g., a low battery; a weather handling condition (e.g., changing inclement weather); a damage condition (e.g., a motor failure); or any combination of these. Each condition may have one or more return criteria associated with the condition. A return criterion for the battery condition may include a low battery condition; the weather handling condition may include a changing inclement weather condition; or for the damage condition may include a motor failure condition.

In some examples, the return criterion can relate to a time window. For instance, when an object for the predicted gunshot event should be continuously monitored, the gunshot detection system 920 can attempt to maintain a representation of the person 990 in sensor data captured by any sensor at the premises. This can include sensor data from fixed sensors at the premises, sensor data from one or more robots, or any combination of these. As part of this process, the gunshot detection system 920 (or the robot system 930) can preemptively determine that a condition will likely satisfy the return criterion within a time window. The condition can be a condition for the robot 926, the person 990, the vehicle, or some other object. The return criterion can be a criterion as described elsewhere in this specification. The system can determine a second monitoring position at which a second robot should monitor an entity for the predicted gunshot event. The second monitoring position can be different from a current monitoring position of the robot 926, which current monitoring system might be different from the monitoring position when the robot 926 was originally deployed. This change in the monitoring position of the robot 926 can occur given movement of the person 990 or other events at the premises. In response to the determination, the system can transmit, to the second robot that is different than the robot 926, a second instruction to cause the second robot to navigate to the second monitoring position to monitor the entity, e.g., the person 990 or the vehicle, for the predicted gunshot event.

The time window can be any appropriate time window. In some examples, the time window can have a predetermined duration, e.g., based on the predicted battery life of the robot 926.

In some instances, the gunshot detection system 920 can maintain at least one criterion for uninterrupted monitoring of an entity associated with a predicted gunshot event. In these situations, the gunshot detection system 920 can perform operations that increase a likelihood that the entity is continuously monitored by a robot from the robot system 930, by a combination of a robot and a sensor device 922, or another appropriate monitoring device.

For instance, the gunshot detection system 920 can transmit an instruction to the robot 926 that causes the robot to monitor the entity when the entity is in a blind spot of the sensor devices 922 while receiving sensor data from at least some of the sensor devices 922 as appropriate. This can include the gunshot detection system 920 transmitting an instruction to a second, different robot that causes the second robot to begin navigating to a position for the entity while the robot 926, a sensor device 922, or both, are monitoring the entity. The position can be a current or a predicted position for the entity. For instance, the position for the second robot can be a different position than a current position of the robot 926.

The robot 926 can determine to perform an action for a satisfied return criterion in any appropriate manner. For instance, the robot 926 an transmit data indicating the one or more conditions that satisfy the return criteria to the robot system 930, the gunshot detection system 920, or both. The robot system 930, the gunshot detection system 920, or both, can determine that at least one of the robot criteria are satisfied. Upon such a determination, the corresponding system can transmit an instruction to the robot 926 indicating that the robot 926 should begin navigation to the predetermined location. This can occur when the system, e.g., the gunshot detection system 920, determines that the data from the robot 926 along with other data indicate that the robot should begin navigation to the predetermined location. For instance, the data can indicate that a second robot is navigating to a position for the predicted gunshot event, is within a threshold distance of the position, or both. In some instances, this can occur when the system determines that other sensor data indicates that the likelihood of harm to another person does not satisfy a likelihood threshold, e.g., no people are in the building 910. In some implementations, the robot 926 may autonomously determine to maneuver to the predetermined location.

If the robot 926 or the robot system 930 determine that the robot 926 should navigate to the predetermined location, the robot system 930 may determine to deploy the second robot. The robot system 930 may determine to cause the second robot to launch from a different robot base, or the robot base 928 from which the robot 926 deploys.

If the robot system 930 determines to deploy the second robot, the robot system 930 may monitor the estimated position with the first robot 926 until the second robot arrives at a location within the threshold distance. The robot system 930 may operate the first robot 926 and the second robot independently or in parallel to monitor the estimated position, the person 990, another object for the predicted gunshot event, or any combination of these. In some examples, the robot system 930 may cause the robot 926 to return to the robot base 928 following the second robot arriving at the second monitoring location.

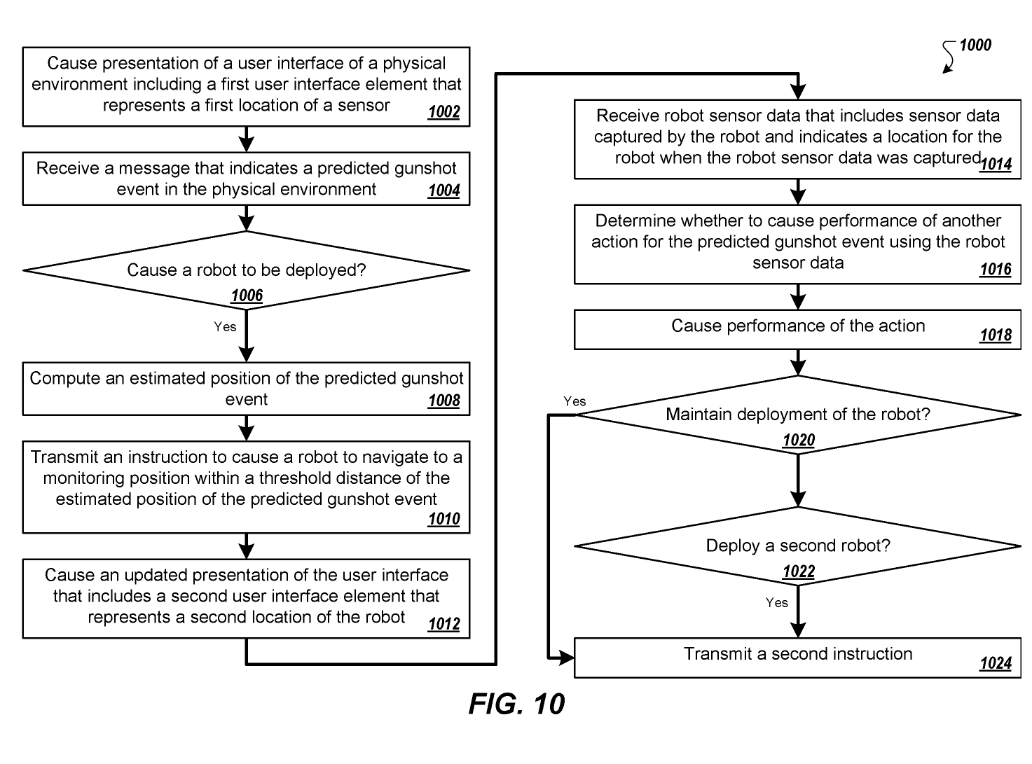

FIG. 10 is a flow diagram of a process 1000 for gunshot analysis using robot augmentation. For example, the process 1000 can be used by the gunshot detection system 920, the robot system 930, or some combination of both, from the environment 900. In FIG. 10, “a system” is generally used to refer to the one or more systems that perform the operations for the process 1000.

A system causes presentation of a user interface of a physical environment including a first user interface element that represents a first location of a sensor (1002). For example, the system can transmit, to a client device, instructions that cause presentation of the user interface. The user interface can depict a representation of the physical environment. For instance, the physical environment can be the environment 900 of FIG. 9 that includes a building 910 at a premises. The user interface can include one or more user interface elements. At least some of the user interface elements can represent corresponding sensor devices, e.g., the physical location of the sensor devices with respect to the building 910. Here, a sensor device can be a remote device in that the sensor device is remote from any robots at the premises. The user interface can optionally depict a user interface element for a location of any deployed, undeployed, or both, robots. The user interface elements can include a corresponding robot type.

The system receives a message that indicates a predicted gunshot event in the physical environment (1004). For example, the system can receive a message from a sensor device, e.g., as the remote device, that indicates the predicted gunshot event. The remote device can include at least one infrared sensor, at least one acoustic sensor, or some combination of both. The system can compute an estimate position for the predicted gunshot event using infrared data, acoustic data, or both. In some instances, the system can use other sensor data, e.g., visible light sensor data, to compute the estimated position.

When the system causes presentation of a user interface, the system can generate instructions for a user interface elements that indicates the estimated position of the predicted gunshot event. The system can transmit the instructions to the client device.

The system determines whether to cause a robot to be deployed (1006). The deployment can include the system transmitting an instruction to the robot to cause the robot to be deployed. In this specification, when a system causes a robot to perform an action, this can include transmission of one or more instructions by the system to the robot. The transmission can use any appropriate communication protocol, e.g., wireless protocol.

The system can make the determination using any appropriate data, process, or both. For instance, the system can use the sensor data, a current status of any robots for the premises, a confidence level of a gunshot event, weather information, permission data, or any combination of these.

In some instances, the system can use a confidence level. The system can compute a confidence level that indicates a likelihood that a gunshot event occurred. The system can use data from the message or other data to compute the confidence level. The system can determine whether the confidence level satisfies a confidence threshold and a robot should be deployed.

In some implementations, the system can use weather data. Sometimes weather can affect the ability of a robot to capture sensor data, safely navigate an environment, or both. The system can use one or more weather criteria that indicate whether a robot is permitted to be deployed given corresponding weather conditions. The weather conditions can be represented as a weather classification of the corresponding physical environment, e.g., for the premises or area in which the robot will likely be deployed. The system can receive the weather classification from a sensor, another system, e.g., a weather system, or both. In instances in which the estimated position has been computed, the system can use the estimated position to determine the weather information.

The system can use permission data that indicates whether the robot is permitted to operate autonomously, whether the robot is permitted to navigate in a particular physical area, or both. A permission criterion can indicate an allowed, a restricted, or some combination of both, action for a robot. In instances in which the estimated position has been computed, the system can use the estimated position to determine whether the permission criterion is satisfied. The permission criterion can indicate whether the gunshot detection system can operation the robot autonomously, e.g., given the estimated position or any location for the robot’s likely navigation.

The system can use the various criteria to determine whether the criteria are satisfied and a robot is permitted to be deployed. When some or all of the criteria are not satisfied, the system can determine to skip deployment of a robot. This can include determining to skip transmitting an instruction that causes a robot to be deployed.

The system computes an estimated position of the predicted gunshot event (1008). For instance, when the system did not previously compute the estimated position, the system can compute the estimated position. This can occur in response to determining to deploy a robot.

The system might need to compute the estimated position when the system receives the message from a sensor device. For example, while a robot might be able to know its position and include data about its position in a message, the sensor device might be agnostic to its actual physical position in its environment. Although the sensor device can predict location data for where a gunshot event might have occurred with respect to the sensor device, e.g., in degrees and distance, the sensor device might not be able to actually compute where in the physical environment that location is since it does not have data that indicates the sensor device’s position within the physical environment.

The system transmits an instruction to cause a robot to navigate to a monitoring position within a threshold distance of the estimated position of the predicted gunshot event (1010) . This can occur in response to determining to deploy a robot. The system can transmit the estimated position, a path, or both, to the robot. The path can be a recommended path for the robot to navigate to get to the estimated position or a monitoring position within a threshold distance of the estimated position. The system can compute the monitoring position using the estimated position, data for the predicted gunshot event, or both. The data for the predicted gunshot event can be a severity of the event, a type of gun that likely caused the event, or both.

The instruction can include an instruction for the robot to capture sensor data while navigating to the monitoring position. This can cause the robot to determine whether the sensor data indicates an updated location for an entity that likely caused the predicted gunshot event. When the robot determines that the sensor data likely indicates an updated location for an entity that likely caused the predicted gunshot event, the robot can navigate to the updated location for the entity that likely caused the predicted gunshot event.

The system causes an updated presentation of the user interface that includes a second user interface element that represents a second location of the robot (1012). When a robot is deployed, the system can update the user interface to include a user interface element that indicates a current position for the robot in the physical environment. The user interface element can indicate that the corresponding object is a robot, e.g., in contrast to a different user interface element used for different types of sensor devices, such as sensor devices that are removable fixed in the physical environment. A sensor device that is removable fixed can include a wall mounted sensor device.

The system receives robot sensor data that includes sensor data captured by the robot and indicates a location for the robot when the robot sensor data was captured (1014). The sensor data can be sensor data that was captured while the robot was navigating to the monitoring position, while the robot was at the monitoring position, or after the robot was at the monitoring position, e.g., and was at a subsequent monitoring position.

The sensor data can be any appropriate type of sensor data, such as acoustic data, video data, e.g., video information, location data, or any combination of these. For instance, while the sensor devices that include gunshot detection sensors might not be able to compute a predicted location of an event, or have data that indicates the physical location of the gunshot detection sensor, the robot has some location data. The robot uses this location data at least to navigate around the premises. The robot can use this location data to indicate a location at which sensor data was captured, compute an updated position for an entity associated with the predicted gunshot event, or both.

In some instances, the system, the robot, or both, can process the video information. This can include determining whether a field of view that is represented by the video information contains a representation of a person, a weapon, or both. The determination can be specific to guns or for any type of weapon.

In some implementations, when the system causes presentation of data in a user interface, the system can cause presentation of at least some of the video information in the user interface. This can include the system selecting the at least some of the video information. The system can generate instructions for presentation of the selected video information. The system can transmit, to the client device, the instructions and at least the selected video information. In instances in which the video information is part of a stream, the system can continue to transmit at least part of the stream of video information.

The system determines whether to cause performance of another action for the predicted gunshot event using the robot sensor data (1016). The other action is an action different than the original deployment of the robot. The system can determine the other action to perform using the robot sensor data; data from other sensors, e.g., that was captured after the receipt of the message indicating the predicted gunshot event; second data for the representation of a person, a weapon, or both; an instruction from another system, e.g., from the client device; or any combination of these. The system can select, from two or more predetermined actions, a specific action to perform for the predicted gunshot event. The system can make the selection using second sensor data captured for the predicted gunshot event. The second sensor data can be captured by the robot, a sensor device, or another appropriate device at or remote from the premises.

When using the video information, e.g., the second data, the system can determine, using a representation of the person, whether the representation of the person is moving in the field of view of the camera of the robot. If so, the system can compute a predicted path that the person is likely to follow. The system can compute a robot path for the robot. The robot path can increase a likelihood of maintaining the representation of the person in the field of view of the camera in the robot. This robot path can be separate from the path for the person given potential obstacles, predicted shortcuts, other appropriate data, or any combination of these.

The system causes performance of the action (1018). For instance, the system generates and transmits instructions to a cause a corresponding device to perform an action. This can include presentation of an alert by the robot or another device at the premises. In some examples, the instruction can be an instruction that causes the robot to begin navigation along the robot path. Some example actions can include: causing a speaker of the robot to broadcast an auditory signal, causing a light of the robot to emit a visual signal, or causing the robot to move to a second position that is different than the monitoring position.

The action can be performed at any appropriate position. For instance, the robot can perform the action at the monitoring position, the estimated position, or both.

The system determines whether to maintain deployment of the robot (1020). For instance, the system can determine whether a return criterion for the robot is satisfied.

The system determines whether to deploy a second robot (1022). The system can have one or more criteria for when a second robot should be deployed. These can include when the robot needs to land because of a low battery; a potential separate gunshot event that might have been causes by a different source, e.g., person, gun, or both; or any combination of these.

For instance, when the system receives a second message that indicates a second predicted gunshot event, the system can determine a likelihood that the predicted gunshot event and the second predicted gunshot event are likely the same event, are within a threshold distance of each other, or both. The threshold distance can be dynamically computed, e.g., using a difference in time that separates the predicted gunshot event and the second predicted gunshot event. For example, when the time between the two events is small, the threshold distance can be smaller than it would if the time between the two events was larger, e.g., indicating an amount of travel time for the gun to move between two positions.

When the system determines that the two events are likely different events, and that the threshold distance is not satisfied, the system can determine to transmit instructions to a second robot, e.g., to deploy the second robot. Transmission of the second instructions can cause the second robot that is different than the robot to navigate to a second monitoring position within a second threshold distance of the second predicted gunshot event. The instruction can cause the second robot to monitor the second position for the second predicted gunshot event.

When the system determines that the threshold distance is satisfied, e.g., and that the two positions are closer together than would occur if the distance was satisfied, the system can determine to cause the robot to navigate to a second monitoring position for the second gunshot event. This can occur after the robot has navigated to the first monitoring position or override the instruction to navigate to the first monitoring position.

The system transmits a second instruction (1024). The system can transmit the second instruction to the second robot or the first robot to cause the respective robot to navigate to the second monitoring position.

The order of operations in the process 1000 described above is illustrative only, and gunshot analysis can be performed in different orders. For example, the process 1000 can perform operation 1008 and then operation 1004. In some instances, the process 1000 can include operation 1014 before or at least partially concurrently with operation 1012. In some instances, the deployment of a second robot can be part of the determination whether to perform an action (operation 1018) or a completely separate determination.

In some implementations, the process 1000 can include additional operations, fewer operations, or some of the operations can be divided into multiple operations. For example, the process 1000 might include only operations 1008, 1010, 1014, 1016, and 1018.

In some examples, some operations might be performed by the robot. For instance, the robot can receive an instruction that indicates that the robot should deploy. The instruction can include navigation data that indicates a monitoring position within a threshold distance of an estimated position of a predicted gunshot event. The instruction can cause the robot to navigate to the monitoring position. While navigating to the monitoring position, the robot can capture sensor data; determine whether the sensor data indicates an updated location for an entity that likely caused the predicted gunshot event; navigate to the updated location for the entity that likely caused the predicted gunshot event; or any combination of these. One or more of these operations might be performed at least partially on a device separate from the robot, e.g., and included in the gunshot detection system, the robot system, or both.

In this specification, the term “database” can broadly refer to any collection of data: the data does not need to be structured in any particular way, or structured at all, and it can be stored on storage devices in one or more locations. A database can be implemented on any appropriate type of memory.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

In this specification the term “engine” can broadly refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

Operations can occur substantially concurrently in that the operations need not be exactly concurrent but can overlap at least in part. For instance, a first operation can begin and sometime after that a second operation can begin while the first operation is still occurring. Execution of the two operations, whether by the same system or different systems, can be substantially concurrent. In some examples, two operations can execute substantially concurrently when they have the same start time, same end time, or both.

In this specification, the term likely can mean that there is a likelihood that something might occur and that the likelihood satisfies a likelihood threshold. For instance, when determining that an object is likely depicted in an image, a system would determine a likelihood that the object is depicted in the image. The system would then determine whether the likelihood satisfies, e.g., is greater than or equal to, a likelihood threshold by comparing the two values. If so, the system determines that the object is likely depicted in the image. If not, the system determines that the object is not likely depicted in the image.

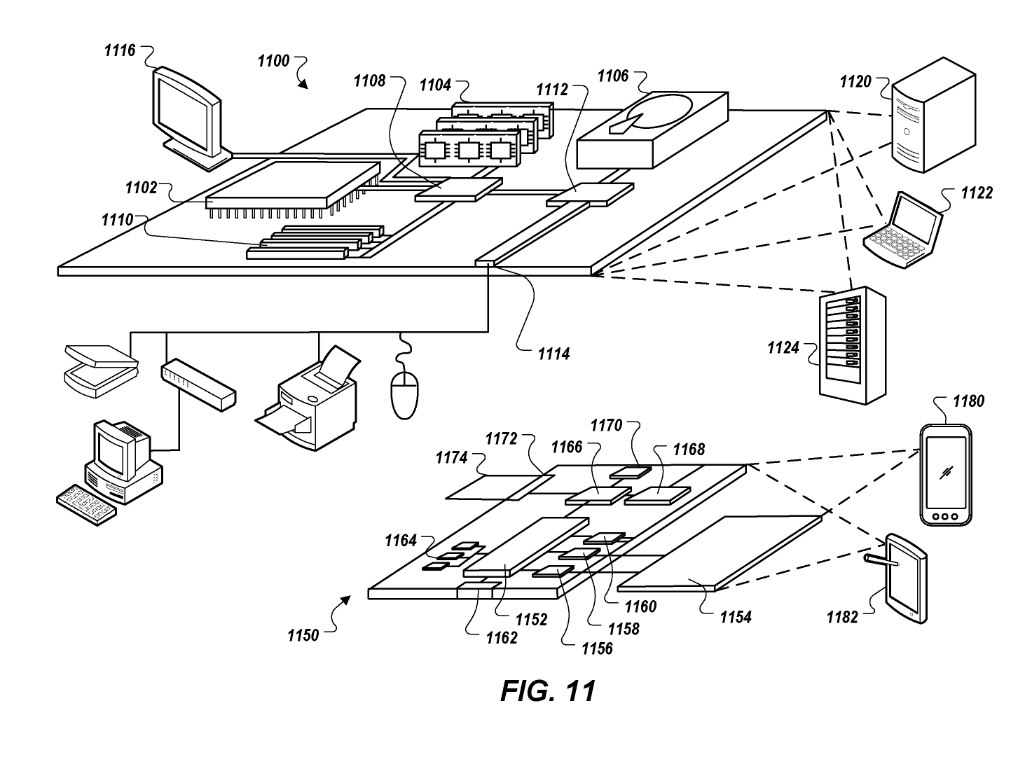

As noted previously, the systems and methods disclosed above utilize data processing apparatus to implement aspects of the gunshot detection using multichannel analysis described herein. FIG. 11 shows an example of a computing device 1100 and a mobile computing device 1150 that can be used as data processing apparatuses to implement the techniques described here. The computing device 1100 is intended to represent various forms of digital computers, such as laptops, desktops, workstations, personal digital assistants, servers, blade servers, mainframes, and other appropriate computers. The mobile computing device 1150 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1100 includes a processor 1102, a memory 1104, a storage device 1106, a high-speed interface 1108 connecting to the memory 1104 and multiple high-speed expansion ports 1110, and a low-speed interface 1112 connecting to a low-speed expansion port 1114 and the storage device 1106. Each of the processor 1102, the memory 1104, the storage device 1106, the high-speed interface 1108, the high-speed expansion ports 1110, and the low-speed interface 1112, are interconnected using various busses, and may be mounted on a common motherboard or in other manners as appropriate. The processor 1102 can process instructions for execution within the computing device 1100, including instructions stored in the memory 1104 or on the storage device 1106 to display graphical information for a GUI on an external input/output device, such as a display 1116 coupled to the high-speed interface 1108. In some implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1104 stores information within the computing device 1100. In some implementations, the memory 1104 is a volatile memory unit or units. In some implementations, the memory 1104 is a non-volatile memory unit or units. The memory 1104 may be another form of computer-readable medium, such as a magnetic or optical disk.

The storage device 1106 is capable of providing mass storage for the computing device 1100. In some implementations, the storage device 1106 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1102), perform one or more methods, such as those described above. The instructions can be stored by one or more storage devices such as computer- or machine-readable mediums (for example, the memory 1104, the storage device 1106, or memory on the processor 1102).

The high-speed interface 1108 manages bandwidth-intensive operations for the computing device 1100, while the low-speed interface 1112 manages lower bandwidth-intensive operations. Such allocation of functions is an example only. In some implementations, the high-speed interface 1108 is coupled to the memory 1104, the display 1116 (e.g., through a graphics processor or accelerator), and to the high-speed expansion ports 1110, which may accept various expansion cards (not shown). In the implementation, the low-speed interface 1112 is coupled to the storage device 1106 and the low-speed expansion port 1114. The low-speed expansion port 1114, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1100 may be implemented in a number of different forms, as shown in the figure. For example, it may be implemented as a standard server 1120, or multiple times in a group of such servers. In addition, it may be implemented in a personal computer such as a laptop computer 1122. It may be implemented as part of a rack server system 1124. Alternatively, components from the computing device 1100 may be combined with other components in a mobile device (not shown), such as a mobile computing device 1150. Each of such devices may contain one or more of the computing device 1100 and the mobile computing device 1150, and an entire system may be made up of multiple computing devices communicating with each other.

The mobile computing device 1150 includes a processor 1152, a memory 1164, an input/output device such as a display 1154, a communication interface 1166, and a transceiver 1168, among other components. The mobile computing device 1150 may be provided with a storage device, such as a micro-drive or other device, to provide additional storage. Each of the processor 1152, the memory 1164, the display 1154, the communication interface 1166, and the transceiver 1168, are interconnected using various buses, and several of the components may be mounted on a common motherboard or in other manners as appropriate.

The processor 1152 can execute instructions within the mobile computing device 1150, including instructions stored in the memory 1164. The processor 1152 may be implemented as a chipset of chips that include separate and multiple analog and digital processors. The processor 1152 may provide, for example, for coordination of the other components of the mobile computing device 1150, such as control of user interfaces, applications run by the mobile computing device 1150, and wireless communication by the mobile computing device 1150.

The processor 1152 may communicate with a user through a control interface 1158 and a display interface 1156 coupled to the display 1154. The display 1154 may be, for example, a TFT (Thin-Film-Transistor Liquid Crystal Display) display or an OLED (Organic Light Emitting Diode) display, or other appropriate display technology. The display interface 1156 may comprise appropriate circuitry for driving the display 1154 to present graphical and other information to a user. The control interface 1158 may receive commands from a user and convert them for submission to the processor 1152. In addition, an external interface 1162 may provide communication with the processor 1152, so as to enable near area communication of the mobile computing device 1150 with other devices. The external interface 1162 may provide, for example, for wired communication in some implementations, or for wireless communication in some implementations, and multiple interfaces may be used.

The memory 1164 stores information within the mobile computing device 1150. The memory 1164 can be implemented as one or more of a computer-readable medium or media, a volatile memory unit or units, or a non-volatile memory unit or units. An expansion memory 1174 may be provided and connected to the mobile computing device 1150 through an expansion interface 1172, which may include, for example, a SIMM (Single In Line Memory Module) card interface. The expansion memory 1174 may provide extra storage space for the mobile computing device 1150, or may store applications or other information for the mobile computing device 1150. Specifically, the expansion memory 1174 may include instructions to carry out or supplement the processes described above, and may include secure information also. Thus, for example, the expansion memory 1174 may be provide as a security module for the mobile computing device 1150, and may be programmed with instructions that permit secure use of the mobile computing device 1150. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. The instructions, when executed by one or more processing devices (for example, processor 1152), perform one or more methods, such as those described above. The instructions can be stored by one or more storage devices, such as one or more computer- or machine-readable mediums (for example, the memory 1164, the expansion memory 1174, or memory on the processor 1152). In some implementations, the instructions can be received in a propagated signal, for example, over the transceiver 768 or the external interface 1162.

The mobile computing device 1150 may communicate wirelessly through the communication interface 1166, which may include digital signal processing circuitry where necessary. The communication interface 1166 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1168 using a radio-frequency. In addition, short-range communication may occur, such as using a Bluetooth, WiFi, or other such transceiver (not shown). In addition, a GPS (Global Positioning System) receiver module 1170 may provide additional navigation- and location-related wireless data to the mobile computing device 1150, which may be used as appropriate by applications running on the mobile computing device 1150.

The mobile computing device 1150 may communicate audibly using an audio codec 1160, which may receive spoken information from a user and convert it to usable digital information. The audio codec 1160 may likewise generate audible sound for a user, such as through a speaker, e.g., in a handset of the mobile computing device 1150. Such sound may include sound from voice telephone calls, may include recorded sound (e.g., voice messages, music files, etc.) and may include sound generated by applications operating on the mobile computing device 1150.

The mobile computing device 1150 may be implemented in a number of different forms, as shown in the figure. For example, it may be implemented as a cellular telephone 1180. It may be implemented as part of a smart-phone 1182, personal digital assistant, or other similar mobile device.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user’s device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a client device, e.g., for purposes of displaying data to and receiving user input from a client device, which acts as a client. Data generated at the client device, e.g., a result of user interaction with the client device, can be received from the client device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations have been described. Other implementations are within the scope of the following claims. For example, the operations recited in the claims, described in the specification, or depicted in the figures can be performed in a different order and still achieve desirable results. In some implementations, multitasking and parallel processing may be advantageous.

What is claimed is:

1. A computer-implemented method comprising:
computing, by a monitoring system, an estimated position of a predicted gunshot event in a physical environment using a message i) received from a remote device in the physical environment, ii) that does not include location data for the remote device, and iii) is for the predicted gunshot event in the physical environment;
transmitting, by the monitoring system and to a robot and using the estimated position of the predicted gunshot event, an instruction to cause the robot to navigate to a monitoring position within a threshold distance of the estimated position of the predicted gunshot event;
receiving, by the monitoring system and from the robot, robot sensor data that includes sensor data captured by the robot and indicates a location for the robot when the robot sensor data was captured;
determining, by the monitoring system, whether to cause performance of another action for the predicted gunshot event using the robot sensor data; and
in response to determining to cause performance of another action for the predicted gunshot event, causing, by the monitoring system, performance of the action.

2. The method of claim 1, comprising:
receiving, by the monitoring system and from the robot, condition data that indicates a condition of the robot;
determining, by the monitoring system and using the condition data, whether the condition of the robot satisfies a return criterion; and
using a result of the determination whether the condition of the robot satisfies the return criterion, transmitting, by the monitoring system and to the robot, an instruction that causes the robot to navigate to a landing station for the robot.

3. The method of claim 2, comprising:
determining, by the monitoring system and using the condition data, that the condition will likely satisfy the return criterion within a time window;
determining a second monitoring position at which a second robot should monitor an entity for the predicted gunshot event; and
transmitting, to the second robot that is different than the robot, a second instruction to cause the second robot to navigate to the second monitoring position to monitor the entity for the predicted gunshot event.

4. The method of claim 3, wherein:
the return criterion indicates that an entity for the predicted gunshot event should be monitored uninterruptedly; and
transmitting the second instruction causes the second robot to begin navigation toward the second monitoring position while the robot is at the monitoring position.

5. The method of claim 1, comprising:
receiving, by the monitoring system and from a device that includes at least one acoustic sensor and is located in the physical environment, a message that indicates a candidate gunshot event;
determining that the candidate gunshot event is a second predicted gunshot event that is different than the predicted gunshot event in the physical environment;
computing, by the monitoring system and using data for the device, a second estimated position of the second predicted gunshot event;
determining, by the monitoring system and using the second estimated position, whether the second estimated position satisfies a distance threshold from the estimate position for the predicted gunshot event; and
in response to determining that the second estimated position does not satisfy the distance threshold from the estimate position for the predicted gunshot event, causing, by the monitoring system and using the second estimated position of the second predicted gunshot event, a second robot that is different than the robot to navigate to a second monitoring position within a second threshold distance of the second predicted gunshot event.

6. The method of claim 1, comprising:
receiving, by the monitoring system and from a device that includes at least one acoustic sensor and is located in the physical environment, a message that indicates a candidate gunshot event;
determining that the candidate gunshot event is a second predicted gunshot event that is different than the predicted gunshot event in the physical environment;
computing, by the monitoring system and using data for the device, a second estimated position of the second predicted gunshot event;
determining, by the monitoring system and using the second estimated position, whether the second estimated position satisfies a distance threshold from the estimate position for the predicted gunshot event; and
in response to determining that the second estimated position satisfies the distance threshold from the estimate position for the predicted gunshot event, causing, by the monitoring system and using the second estimated position of the predicted second gunshot event, the robot to navigate to a second monitoring position.

7. The method of claim 6, wherein the second monitoring position is within a second threshold distance of the second predicted gunshot event and the predicted gunshot event.

8. The method of claim 1, comprising:
determining, by the monitoring system, whether to cause the robot to be deployed, wherein transmitting, by the monitoring system and to the robot, the instruction is responsive to determining to cause the robot to be deployed.

9. The method of claim 8, wherein determining whether to cause the robot to be deployed comprises:
determining, using data for the message, a confidence level that indicates a likelihood that a gunshot event occurred; and
determining whether the confidence level satisfies a confidence threshold and a robot should be deployed.

10. The method of claim 8, wherein determining, by the monitoring system, whether to cause the robot to be deployed comprises:
accessing, by the monitoring system, permission information indicating whether the system is permitted to operate the robot autonomously;
in response to determining that the system is not permitted to operate the robot autonomously, transmitting, by the monitoring system and to a robot operation system a request for an operator to operate the robot; and
in response to the monitoring system receiving a response to the request, enabling, by the monitoring system, operation of the robot by the operator.

11. The method of claim 1, wherein:
receiving, by the monitoring system and from the robot, the robot sensor data comprises:
receiving, by the monitoring system, video information representing a field of view of a camera of the robot; and
determining, by the monitoring system and using the video information representing the field of view of the camera, whether the video information contains a representation of a person, a weapon, or both; and
causing, by the monitoring system, performance of the action uses second data for the representation of a person, a weapon, or both.

12. The method of claim 11, wherein the video information contains a representation of a person, the method comprising:
determining, by the monitoring system and using the video information representing the field of view of the camera and the representation of the person, whether the representation of the person is moving in the field of view of the camera of the robot;
in response to determining that the representation of the person is moving in the field of view of the camera, computing, by the monitoring system, a path that the representation of the person is likely to follow;
computing, by the monitoring system and using the path of the representation of the person is likely to follow, a robot path which increases a likelihood of maintaining the representation of the person in the field of view of the camera; and
transmitting, by the monitoring system and to the robot, an instruction that indicates that the robot should begin navigation along the robot path.

13. The method of claim 1, comprising:
generating, for presentation in a user interface:
a first user interface element that indicates the estimated position of the predicted gunshot event in the physical environment;
a second user interface element that indicates a current position for the robot in the physical environment;
a third user interface element that indicates a location of the remote device in the physical environment; and
causing presentation of the user interface on a display.

14. A system comprising one or more computers and one or more storage devices on which are stored instructions that are operable, when executed by the one or more computers, to cause the one or more computers to perform operations comprising:
receiving, by a robot included in the system, navigation data that indicates a monitoring position within a threshold distance of an estimated position of a predicted gunshot event and includes an instruction for the robot to navigate to the monitoring position;
while navigating to the monitoring position:
capturing sensor data;
determining whether the sensor data indicates an updated location for an entity that likely caused the predicted gunshot event; and
in response to determining that the sensor data indicates an updated location for an entity that likely caused the predicted gunshot event, navigating to the updated location for the entity that likely caused the predicted gunshot event.

15. The system of claim 14, wherein:
receiving the navigation data comprises receiving navigation data that was computed by another system using remote sensor data captured by a remote sensor in a physical environment that includes the predicted gunshot event and location data computed using a predetermined location for the remote sensor; and
capturing the sensor data comprises:
capturing the sensor data;
computing a likely location of the robot when the sensor data was captured; and
associating the sensor data with the likely location; and
navigating to the updated location uses the likely location of the robot when the sensor data was captured that was associated with the sensor data.

16. The system of claim 15, wherein the remote sensor data captured by the remote sensor does not include location data.

17. The system of claim 15, the operations comprising:
determining, using second sensor data captured by the robot or an instruction from another system, whether to perform an action for the predicted gunshot event;
in response to determining to perform an action for the predicted gunshot event, selecting, from two or more predetermined actions, a specific action to perform for the predicted gunshot event; and
performing, by the robot, the specific action, the specific action comprising one or more of:
causing a speaker of the robot to broadcast an auditory signal,
causing a light of the robot to emit a visual signal, or
causing the robot to move to a second position that is different than the monitoring position.

18. The system of claim 17, wherein performing the specific action comprises performing the action at the monitoring position.

19. The system of claim 17, wherein selecting the specific action uses second sensor data captured for the predicted gunshot event.

20. One or more computer storage media encoded with instructions that, when executed by one or more computers, cause the one or more computers to perform operations comprising:
computing, by a monitoring system, an estimated position of a predicted gunshot event in a physical environment using a message i) received from a remote device in the physical environment, ii) that does not include location data for the remote device, and iii) is for the predicted gunshot event in the physical environment;
transmitting, by the monitoring system and to a robot and using the estimated position of the predicted gunshot event, an instruction to cause the robot to navigate to a monitoring position within a threshold distance of the estimated position of the predicted gunshot event;
receiving, by the monitoring system and from the robot, robot sensor data that includes sensor data captured by the robot and indicates a location for the robot when the robot sensor data was captured;
determining, by the monitoring system, whether to cause performance of another action for the predicted gunshot event using the robot sensor data; and
in response to determining to cause performance of another action for the predicted gunshot event, causing, by the monitoring system, performance of the action.
